(19) United States
(12) Patent Application Publication
(10) Pub. No.: US 2006/0205628 A1
(43) Pub. Date: Sep. 14, 2006

(54) Detergent compositions

(75) Inventors: Randall Deinhammer, Wake Forest, NC (US); Signe Munk, Charlottenlund (DK); Ture Damhus, Copenhagen O (DK); Thomas Honger Callisen, Frederiksberg C (DK); Jesper Duus Nielsen, Copenhagen N (DK)

Correspondence Address: NOVOZYMES NORTH AMERICA, INC., 500 FIFTH AVENUE, SUITE 1600, NEW YORK, NY, 10110, US

(73) Assignee: Novozymes A/S, Bagsvaerd (DK)

(21) Appl. No.: 10/546,143

(22) PCT Filed: Jan. 19, 2004
(86) PCT No.: PCT/DK04/00026

§ 371 Date: Aug. 18, 2005

(30) Foreign Application Priority Data
Feb. 18, 2003 (DK) PA 2003 00245

(51) Int. Cl. C11D 3/48

(52) U.S. Cl. 510/386

(57) ABSTRACT

The present invention relates to the replacement of surfactants, builders, polymers and bleaches in detergent compositions with enzymes.

### FIELD OF THE INVENTION

The present invention relates to detergent compositions comprising enzymes and reduced amounts of conventional detergent components.

### BACKGROUND OF THE INVENTION

Surfactants, builders, bleaches and polymers are used in detergent compositions with success but there are some drawbacks in using these components. Some surfactants are known not to be completely biodegradable, builders such as phosphate builders are known to cause eutrophication of rivers, lakes and seas, zeolite builders are insoluble in water and cause pollution of the environment, and furthermore zeolites may show up as white specks on dark colored clothes when used in laundry detergent compositions. Bleach activators and their peracid perhydrolysis products are not completely biodegradable, furthermore they are known to make other important detergent ingredients unstable. Soil suspending polymers are also not fully biodegradable. These conventional detergent components have for many years been added to the detergent compositions, but with the increasingly higher environmental awareness it has been discovered that these conventional detergent components are potential hazards to the environment.

Not all kinds of soils can be satisfactorily removed using conventional detergents comprising surfactants, builders, soil suspending polymers and bleaches. Therefore enzymes have been widely used in detergent compositions as a supplement to the before mentioned detergent components, as they provide a higher detergency effect on some soils compared to surfactants, builders, polymers and bleaches.

WO 01/74980 describes enzyme tablets having a size of more than 10.5 mm in its longest dimension and wherein the non enzyme components of the particle have a detergency of less than 4.

Eiichi Hoshino et al. discloses replacement of surfactants by cellulase in Journal of Surfactants and Detergents, Vol. 3, No. 3, July 2000, p. 317 to p. 325; Improvement of Cotton Cloth Soil Removal by Inclusion of Alkaline Cellulase from Bacillus sp. KSM-635 in Detergents. In general the function of surfactant, builder, polymer, and bleach in detergents is described in Powdered Detergents, M. S. Showell, ed., Surfactant Science Series, vol. 71, Marcel Dekker, New York, 1998. Surfactants—by K. H. Raney—pp. 241-284, builders by H. P. Rieck—pp. 43-108, polymers by G. Swift—pp. 109-136, bleach by M. E. Burns, G. S. Miracle, A. D. Willey—pp. 165-204).

### SUMMARY OF THE INVENTION

Surfactants, builders, bleaches and polymers are traditional components used in detergents with success but as mentioned vide supra each of them have some drawbacks. There has been a wish for replacing the most problematic components with none hazardous compounds while still keeping the good performance obtained with these components. In addition, these components typically take up most of the cost of the detergent compositions due either to their high usage percentage in detergents and/or to their high raw material costs. This is a further reason for trying to replace them.

The inventors have surprisingly found that these detergent components can be partly or fully replaced by enzymes, whereby they have found an alternative to using surfactants, builder, polymers and bleaches in detergents.

Hence one object of the present invention is to provide detergent compositions comprising either no or at least decreased amounts of surfactants, builders, polymers, and bleaches while still providing superior cleaning.

The inventors have surprisingly found that enzymes are not just capable of adding additional detergency to detergent compositions but some enzymes can actually be used as an alternative to the before mentioned detergent components, as enzymes have been found to provide the same detergency as some surfactants, builders, polymers and bleaches provide to detergent compositions. It has been found that enzymes can be used to fully replace or partly replace the before mentioned detergent components in detergent compositions while providing same level of detergency or even improving the overall detergency of the detergent compositions.

Hence the present invention provides a detergent composition, which comprises:

0% to 30% w/w of surfactant, 0% to 50% of builder and at least 0.00001% of enzyme protein by weight of the detergent composition, or

0% to 30% of surfactant, 0% to 50% of builder, 0% to 6% of polymers and at least 0.00001% of enzyme protein by weight of the detergent composition, or

0% to 30% of surfactant, 0% to 50% of builder, 0% to 15% of bleaches and at least 0.00001% of enzyme protein by weight of the detergent composition, or

0% to 30% of surfactant, 0% to 50% of builder and at least 0.00001% of enzyme protein by weight of the detergent composition, wherein the contribution to the detergency provided by enzymes in the detergent composition is more than 5% and the detergency of the detergent composition is measured by performing a full-scale wash under Standard North American conditions on 15 commercially available 100% cotton swatches stained with baby food, tea, spaghetti sauce, makeup, clay, beta carotene, blood, curry sauce, butter, grass, chocolate dessert, red wine, used engine oil, animal fat/dye, and garden peat and adding the average remissions obtained on each of these stains together for each of the treatments, and the contribution to the detergency provided by enzymes is found by comparing the total of the 15 average remissions obtained from the same detergent with and without enzymes.

The inventors have further found that specific combinations of enzymes have particular advantages in replacing said detergent components.

### DETAILED DESCRIPTION OF THE INVENTION

Definitions

By an “alkaline solution” is understood a solution which has a pH above 7, preferably a pH from 8.5 to 11.

By “launder-o-meter wash under Standard European conditions” is meant a single-cycle simulated European wash conducted in 1,2 liter beakers using a launder-o-meter (Atlas LP2). The wash was conducted in deionized water at a hardness of 14°dH (3:1 Ca:Mg) and an NaHCO₃ concentration of 5 mM using a 10 minute temperature ramp from 25-40° C., and then a 20 minute wash at 40° C. The detergent dosage was 5 g/L for European powders and liquids. A total water/fabric ratio of 20/1 was used, and the fabric load included all of the stained textiles plus an equal amount of clean 100% polyester and 100% cotton tracer fabrics. Three rinses of the textiles were done for 5 minutes each under cold tap water. After the wash and rinses, the fabrics were separated and allowed to air dry overnight in the dark prior to measurement of their remissions. The remissions of the textiles were measured at 460 nm with a UV filter using a MacBeth color eye system.

By “full-scale wash under Standard European conditions” is meant a single-cycle European wash was conducted in AEG washers. The wash was conducted using the short cycle program in deionized water at a hardness of 14°dH (3:1 Ca:Mg) and an NaHCO₃ concentration of 5 mM. The wash temperature was 40° C. The detergent dosage was 5 g/L for European powders and liquids. A total fabric load of 4 kg was used, including all soiled and clean ballast textiles. Three to 5 repetitions of each wash were used. After the wash, the fabrics were separated and allowed to air dry overnight in the dark prior to measurement of their remissions. The remissions of the textiles were measured at 460 nm with a UV filter using a MacBeth color eye system.

By “full-scale wash under Standard North American conditions” it is meant that a single-cycle Standard North American wash was conducted in Kenmore US top loading machines using the regular setting. A total wash time of 12 minutes at 32° C. was used at a water hardness of 6 dH (2:1 Ca:Mg) and a NaHCO₃ dosage of 11 g/wash. The total fabric load was 2.7 kg and the total fill volume was 62 L. Five wash repetitions were used. The detergent dosage was 1.5 g/L. After washing, the fabrics were separated and allowed to air dry overnight in the dark prior to measurement of their remissions. The remissions of the textiles were measured at 460 nm with a UV filter using a MacBeth color eye system.”

By “terg-o-tometer wash under standard North American washing conditions” is meant a single-cycle simulated North American wash conducted in 2 litre beakers using a terg-o-tometer apparatus (Novo Nordisk). The wash was conducted in deionized water at a hardness of 6°dH (2:1 Ca:Mg) and an NaHCO₃ concentration of 2,14 mM using a 12 minute wash at 32° C. and 120 rpm stirring rate. The detergent dosage was 1 g/L for North American powders. A total water/fabric ratio of 45/1 was used, and the fabric load included all of the stained textiles plus an equal amount of clean 100% polyester and 100% cotton tracer fabrics. Three rinses of the textiles were done for 5 minutes each under cold tap water. After the wash and rinses, the fabrics were separated and allowed to air dry overnight in the dark prior to measurement of their remissions. The remissions of the textiles were measured at 460 nm with a UV filter using a MacBeth color eye system.

By “terg-o-tometer wash under standard Asia-pacific washing conditions” is meant a single-cycle simulated Asian-Pacific wash conducted in 2 litre beakers using a terg-o-tometer apparatus (Novo Nordisk). The wash was conducted in deionized water at a hardness of 3°dH (2:1 Ca:Mg) and an NaHCO₃ concentration of 1,07 mM using a 12 minute wash at 20° C. and 120 rpm stirring rate. The detergent dosage was 0,5 g/L or 0,67 g/L for Asia-pacific powders. A total water/fabric ratio of 45/1 was used, and the fabric load included all of the stained textiles plus an equal amount of clean 100% polyester and 100% cotton tracer fabrics. Three rinses of the textiles were done for 5 minutes each under cold tap water. After the wash and rinses, the fabrics were separated and allowed to air dry overnight in the dark prior to measurement of their remissions. The remissions of the textiles were measured at 460 nm with a UV filter using a MacBeth color eye system.

The term “detergency” of a compound or a composition as used in the present application is to be understood as the ability of a composition to remove soils from a fabric, determined by measuring the amount of light reflected from the fabric (remission) before and after treatment of the fabric with the composition. According to the present invention the contribution to the detergency provided by enzymes is determined on 15 commercially available 100% cotton swatches (for example available from Equest Research) stained with the normally occurring solings of (1) baby food, (2) tea, (3) spaghetti sauce, (4) makeup, (5) clay, (6) beta carotene, (7) blood, (8) curry sauce, (9) butter, (10) grass, (11) chocolate dessert, (12 red wine, (13) used engine oil, (14) animal fat/dye, and (15) garden peat. These swatches are washed in any of the above mentioned (1) launder-o-meter wash under Standard European conditions; (2) full-scale wash under Standard European conditions; (3) full-scale wash under Standard North American conditions; (4) terg-o-tometer wash under standard North American conditions or (5) terg-o-tometer wash under standard Asia-pacific conditions. Preferably the full-scale wash under Standard North American conditions is performed.

The detergency of the detergent or components therein is calculated by adding the average remissions obtained on each of these stains together for each of the treatments. The contribution to the detergency provided by enzymes is found by comparing the total of the 15 average remissions obtained from tests performed with the same detergent with and without enzymes. The contribution to the detergency provided by enzymes modulated by one surfactant system compared to another surfactant system is found by comparing the total of the 15 average remissions obtained from tests performed with a detergent composition comprising either the first or the second surfactant system and with or without the enzymes.

Introduction

Detergent manufacturers want to obtain a balance between formulating none hazardous products, maximizing detergent performance and minimizing formulation costs. Detergent formulation costs as well as manufacturing costs both contribute to the total cost of formulating a detergent. The inventors have surprisingly found that one way of reducing formulation costs, still keeping or even improving the good cleaning performance and furthermore getting more environmentally-friendly products, is by replacing surfactants, builders, polymers and bleaches with enzymes. The inventors have found that it is possible to replace more than 20% and even more than 50% in some detergent compositions, of the detergent components with enzymes and still obtain a good or even improved cleaning result compared to the detergent compositions with normal level of conventional detergent components. In a particular embodiment 1 to 100% of one or more detergent components selected from the group consisting of surfactants, builders, polymers and bleaches are replaced by enzymes, in a more particular embodiment of the present invention 20 to 80% of one or more detergent components selected from the group consisting of surfactants, builders, polymers and bleaches are replaced by enzymes, in a most particular embodiment of the present invention 30 to 60% of one or more detergent components selected from the group consisting of surfactants, builders, polymers and bleaches are replaced by enzymes.

Surfactants are used in detergent compositions to help remove and suspend soil such as triglyceride based soils and hydrocarbon based soils, examples are butter fat, body soil and vegetable oil. Builders are widely used in detergent composition to decrease water hardness, to control the pH and to improve general detergency in the composition. Polymers, and in particular soil-suspending polymers, are used in detergents to help keep particulate soil such as clay, mud, etc. suspended in the wash water. This suspension property helps to prevent the redeposition of the soils during the rinsing cycle. Bleaches are used to remove soil like coffee, tea and wine. (Reference for surfactant, builder, polymer, and bleach function in detergents: Powdered Detergents, M. S. Showell, ed., Surfactant Science Series, vol. 71, Marcel Dekker, New York, 1998. Surfactants—by K. H. Raney—pp. 241-284, builders by H. P. Rieck—pp. 43-108, polymers by G. Swift—pp. 109-136, bleach by M. E. Burns, G. S. Miracle, A. D. Willey—pp. 165-204).

Replacing parts of the surfactants, builders, bleach, fillers in a detergent with enzymes, whether it is only one component or more components that are partially (or even completely) replaced, results in significant reductions of the volume and weight of the detergent necessary for one wash. There are many advantages and benefits from this, including less demand for space and investment in detergent production facilities, less cost for transport and packaging, energy savings and reduced environment impact from chemicals, etc.

Other benefits relate to the product form. As the volume necessary for one wash is reduced, the need for assisting the consumer in correct dosing of the detergent increases. Thus unit dosage forms could be a particularly suitable product form. This could be in the form of a small pill, a tablet, a powder pouch, a liquid measurement system or a liquid package, or any combination of these.

Another product form and method of delivery could be automatic dosage systems, which becomes more realistic when volume is decreased dramatically. Automatic dosing can be combined with intelligent computer control of the washing process where dosage is determined by the washing machine, taking degree of soiling on garments, water hardness, chosen program etc into consideration when deciding how much detergent to dose. One can imagine that the enzyme part of a detergent is separated from the auxiliaries (remaining surfactants, builders etc), and that the two parts are dosed independently during wash and as the washing result materializes.

Preferred enzymes of the present invention are lipases, proteases, amylases, cellulases and oxidoreductases, pectinases, lipoxygenaser cutinases, hemicellulases, to fully replace or at least partly replace these components in detergents. For example lipases can act to remove soil like lipstick, olive oil, lard and chicken fat as surfactants do in detergents. Hence surfactants may according to the invention be replaced with a lipase in detergent compositions. In a particular embodiment of the present invention lipases are used to partly replace or fully replace surfactants in detergent compositions. The inventors have further found that cellulases can work to both remove soils such as mud, clay and carbon black particularly on textiles and also to prevent the redeposition of soil through their action on particularly cotton-based textiles. Cellulases can therefore act to replace surfactants, builders and soil-suspending polymers as well. In a particular embodiment of the present invention cellulases are used to partly replace or fully replace surfactants. In another embodiment of the present invention cellulases are used to partly replace or fully replace builders in detergent compositions. In a third embodiment cellulases are used to partly replace or fully replace polymers in detergent compositions. The inventors have also found that the action, of both proteases and amylases in the detergent wash, can significantly help to improve the overall removal of soils and to prevent redeposition. Amylases remove starch based soils such as chocolate sauce and rice starch. Proteases remove protein based soils such as sebum and grass. In a particular embodiment of the present invention proteases and/or amylases are used to partly replace or fully replace surfactants, polymers and/or builders in detergent composition. The inventors have further found that certain oxidoreductases can be used to replace bleaches in detergent compositions through their ability to bleach bleach-sensitive stains such as tea, wine, and coffee. In a particular embodiment of the present invention bleaches are partly replaced or fully replaced by oxidoreductases.

The inventors have found that some enzymes are capable of providing some of or all of the detergency provided by surfactants, builders, polymers and bleaches in detergent compositions and these enzymes can therefore be used as an alternative to the mentioned detergent components, and by replacing them partly or fully, it is still possible to obtain the same or better overall cleaning performance. The contribution to the detergency provided by enzymes is normally found to be less than 5% in detergent compositions, but after partly replacement of surfactants, builders, polymers and/or bleaches with enzymes the contribution to the detergency provided by enzymes is increased to more than 5%, where the detergency is measured according to the definition of “detergency” described vide supra.

In a particular embodiment of the present invention the detergency accounted for in the detergent composition is 5 to 100%, more preferred 10 to 60%, even more preferred 15 to 50%.

In a particular embodiment of the present invention non-enzyme components of the detergent composition contribute with more than 5% of the detergency, where the detergency is measured according to the definition of “detergency” described vide supra.

The detergent composition of the invention may be a laundry detergent composition for hand or machine washings including a composition suitable for pre-treatment of stained fabrics, or a detergent composition for use in general household hard surface cleaning operations, or a composition for hand or machine dishwashing operations.

Enzymes

The detergent composition of the present invention comprises one or more enzymes. In a particular embodiment of the present invention the enzymes are selected from the group consisting of lipases, cellulases, amylases, proteases and oxidoreductases.

In general the properties of the chosen enzyme(s) should be compatible with the selected detergent, (i.e. pH-optimum, compatibility with other enzymatic and non-enzymatic ingredients, etc.).

The enzyme or enzymes are incorporated in the detergent composition at a level of at least 0.00001% of enzyme protein by weight of the composition. In a particular embodiment the enzyme(s) is incorporated in the detergent composition at a level of at least 0.0001% of enzyme protein by weight of the composition. In a more particular embodiment the enzyme is incorporated in the detergent composition at a level of at least 0.001% of enzyme protein by weight of the composition.

In a particular embodiment the enzyme is incorporated in the detergent composition at a level of less than 99% of enzyme protein by weight of the composition. In a more particular embodiment the enzyme(s) is incorporated in the detergent composition at a level of less than 80% of enzyme protein by weight of the composition. In an even more particular embodiment the enzyme(s) lipase is incorporated in the detergent composition at a level of less than 50% of enzyme protein by weight of the composition. In an even more particular embodiment the enzymes(s) is incorporated in the detergent composition at a level of less than 20% of enzyme protein by weight of the composition.

Lipases

In a particular embodiment of the present invention the enzyme used to partly replace or fully replace surfactants is a lipase.

Any lipase suitable for use in alkaline solutions can be used. Suitable lipases include those of bacterial or fungal origin. Chemically or genetically modified or protein engineered variants are included. Examples of useful lipases include lipases from Humicola (synonym Thermomyces), e.g. from Humicola lanuginosa (Thermomyces lanuginosus) as described in EP 258 068 and EP 305 216 or from Humicola insolens as described in WO 96/13580, lipases from Rhizomucor miehei lipase, e.g., as described in EP 238 023, lipases from Candida, such as a C. antarctica lipase, e.g., the C. antarctica lipase A or B described in EP 214 761, lipases from Pseudomonas, e.g. from Pseudomonas alcaligenes or Pseudomonas pseudoalcaligenes (EP 218 272), P. cepacia (EP 331 376), Pseudomonas stutzeri (GB 1,372,034), Pseudomonas fluorescens, Pseudomonas sp. strain SD 705 (WO 95/06720 and WO 96/27002), Pseudomonas wisconsinensis (WO 96/12012), lipases from Bacillus, e.g. from B. subtilis (Dartois et al. (1993), Biochemica et Biophysica Acta, 1131, 253-360), B. stearothermorphilus (JP 64/744992) or B. pumilus (WO 91/16422).

In a particular embodiment of the present invention the lipase used to partly replace or fully replace the surfactant is derived from a microorganism selected from the group consisting of Humicola, Pseudomonas and Bacillus.

Furthermore, a number of cloned lipases may be useful, including the Penicillium camembertii lipase described by Yamaguchi et al., (1991), Gene 103, 61-67), the Geotricum candidum lipase (Schimada, Y. et al., (1989), J. Biochem., 106, 383-388), and various Rhizopus lipases such as a R. delemar lipase (Hass, M. J et al., (1991), Gene 109, 117-113), a R. niveus lipase (Kugimiya et al., (1992), Biosci. Biotech. Biochem. 56, 716-719) and a R. oryzae lipase. Other types of lipolytic enzymes such as cutinases may also be useful, e.g. a cutinase derived from Pseudomonas mendocina as described in WO 88/09367, or a cutinase derived from Fusarium solani pisi (e.g. described in WO 90/09446). In a particular embodiment of the present invention the enzyme used to partly replace or fully replace surfactants is a cutinase, in a more particular embodiment the enzyme used to partly or fully replace surfactants are derived from Pseudomonas mendocina or Fusarium solani pisi.

Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202.

Preferred commercially available lipase enzymes include LIPEX™, LIPOLASE™ and LIPOLASE ULTRA™ (Novozymes A/S).

Other commercially available lipases include M1 LIPASE™, LUMAFAS™ (Pseudomonas mendocina lipase and Pseudomonas putida lipase from Genencor International Inc.); LIPOMAX™ (P. pseudoalcaligenes lipase from DSM/Genencor Int. Inc.; and Bacillus sp. lipase). Lipase P “Amano” (Amano Pharmaceutical Co. Ltd.). Further lipases are available from other suppliers.

In a particular embodiment of the present invention the lipase is incorporated in the detergent composition at a level of 0.00001 to 2% of enzyme protein by weight of the detergent composition, in a particular embodiment of the present invention the lipase is incorporated at a level of 0.0001% to 1% of enzyme protein by weight of the composition, more particularly at a level of 0.001% to 0.5% of enzyme protein by weight of the composition, even more particularly at a level of from 0.001% to 0.04% of enzyme protein by weight of the composition, in a most particular embodiment the level is 0.005% to 0.1%.

In a particular embodiment of the present invention the lipase or lipolytic enzyme used to partly replace or fully replace surfactants is added in the amount of 0.005% to 0.1% of enzyme protein by weight of the detergent composition, in a more particular embodiment the lipase or lipolytic enzyme used to replace or fully replace surfactants is added in the amount of 0.001 to 0.04%.

In a particular embodiment of the present invention the powder detergent composition comprises surfactants at a level of 0% to 30% by weight of the total composition after replacement of surfactants with lipase. In a more particular embodiment of the present invention the powder detergent composition comprises surfactants at a level of 0% to 20% by weight of the total composition after replacement of surfactants with lipase. In an even more particular embodiment of the present invention the powder detergent composition comprises surfactants at a level of 0% to 10% by weight of the total composition after replacement with lipase. In a most particular embodiment of the present invention the powder detergent comprises surfactants at a level of 0% to 6% by weight of the total composition after replacement with lipase.

In a particular embodiment of the present invention the liquid detergent composition comprises 0% to 30% by weight of surfactants after replacement of surfactants with lipase, in a more particular embodiment of the present invention the liquid detergent composition comprises 0% to 20% by weight of surfactant after replacement with lipase, in an even more particular embodiment of the present invention the liquid detergent composition comprises 4% to 20% by weight of surfactant after replacement with lipase, in a most particular embodiment of the present invention the liquid detergent composition comprises 5% to 15% by weight of surfactant after replacement with lipase.

In a particular embodiment of the present invention the detergent composition comprise at least 0.01% by weight of surfactant. In a more particular embodiment of the present invention the detergent composition comprises at least 1% by weight of surfactant. In a most particular embodiment of the present invention the detergent composition comprises at least 3% by weight of surfactant. In a particular embodiment of the present invention the detergent composition comprise less than 30% by weight of surfactant. In a more particular embodiment of the present invention the detergent composition comprise less than 15% by weight of surfactant. In a most particular embodiment of the present invention the detergent composition comprise less than 10% by weight of surfactant.

Due to the odor of lipase hydrolysis products detergent compositions are almost always formulated with fragrances.

Cellulases

In a particular embodiment of the present invention an endo-glucanase, a cellulase, a hemicellulase or a cellobiohydrolase is used to partly replace or fully replace detergent components selected from the group consisting of surfactants, polymers and builders in detergent compositions.

Any cellulase suitable for use in alkaline detergent solutions can be used. Suitable cellulases include those of bacterial or fungal origin. Chemically or genetically modified or protein engineered variants are included. Suitable cellulases include cellulases from the genera Bacillus e.g. Bacillus sp., Bacillus subtilis, Pseudomonas, Humicola, Fusarium, Thielavia e.g. T. terrestris, Acremonium, e.g. the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259, WO 02/099091. Also cullelase from Trichoderma or Melanocarpus are contemplated

In a particular embodiment of the present invention the cellulase used to party replace or fully replace surfactants, builders or polymers is derived from a microorganism selected from the group consisting of Bacillus, Humicola and Pseudomonas. In a more particular embodiment of the present invention the cellulases used to partly replace or fully replace surfactants, polymers and/or builders in detergent composition are derived from microorganism selected from the group consisting of Bacillus subtilis, Humicula insolens and Thielavia terrestris.

Other suitable cellulases which can be used to partly replace or fully replace surfactants, builders and polymers are the alkaline or neutral cellulases which additional have colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and WO 99/01544.

Another suitable cellulase is an endo-type alkaline cellulase, 1,4-(1,3;1,4)-beta-D-glucan 4-glucanohydrolase(EC 3.2.1.4), produced by Bacillus sp. KSM-635 and the endoglucanase derived from Bacillus sp. KSM-S237 deposited as FERM P-16067 and shown in position 1 to 824 of SEQ ID NO: 1 of JP 2000210081 A (hereby incorporated by reference) and the endoglucanases described in WO 02/099091 (hereby incorporated by reference).

In a particular embodiment of the present invention the cellulase used to partly replace or fulle replace surfactants, polymers and/or builders are endo-glucanases. In another embodiment of the present invention the cellulase used to partly replace or fully replace surfactants, polymers and/or builders is an exo-glucanase.

Commercially available cellulases include CELLUZYME™, ENDOLASE™, RENOZYME™ and CAREZYME™ (Novozymes A/S), CLAZINASE™, and PURADAX HA™ (Genencor International Inc.), and KAC-500(B)™ (Kao Corporation).

Cellulases can be incorporated in the detergent composition at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.001% to 0.2% of enzyme protein by weight of the composition.

In a particular embodiment of the present invention the amount of cellulase added to the detergent composition to partly replace or fully replace surfactants and/or builders and/or polymers are 0.001% to 0.5% of enzyme protein by weight of the composition. In a more particular embodiment of the present invention the amount of cellulase added to partly replace or fully replace surfactants and/or builders and/or polymers are 0.001% to 0.2%.

In a particular embodiment of the present invention the powder detergent composition comprises surfactants at a level of 0% to 30% by weight after replacement of surfactants with cellulase. In a more particular embodiment of the present invention the powder detergent composition comprises surfactants at a level of 0% to 20% by weight after replacement of surfactants with cellulase. In an even more particular embodiment of the present invention the powder detergent composition comprises surfactants at a level of 0% to 10% by weight after replacement with cellulase. In a most particular embodiment of the present invention the powder detergent comprises surfactants at a level of 0% to 6% by weight after replacement with cellulase.

In a particular embodiment of the present invention the liquid detergent composition comprises 0% to 30% of surfactants after replacement of surfactants with cellulase, in a more particular embodiment of the present invention the liquid detergent composition comprises 0% to 20% of surfactant after replacement with cellulase, in an even more particular embodiment of the present invention the liquid detergent composition comprises 4% to 20% of surfactant after replacement with cellulase, in a most particular embodiment of the present invention the liquid detergent composition comprises 5% to 15% of surfactant after replacement with cellulase.

In a particular embodiment of the present invention the detergent composition comprise at least 0.01% by weight of surfactant. In a more particular embodiment of the present invention the detergent composition comprises at least 1% by weight of surfactant. In a most particular embodiment of the present invention the detergent composition comprises at least 3% by weight of surfactant. In a particular embodiment of the present invention the detergent composition comprise less than 30% by weight of surfactant. In a more particular embodiment of the present invention the detergent composition comprise less than 15% by weight of surfactant. In a most particular embodiment of the present invention the detergent composition comprise less than 10% by weight of surfactant.

In a particular embodiment of the present invention the detergent composition comprises less than 6% of polymer after replacement with cellulase, in a more particular embodiment of the present invention the detergent composition comprises less than 4% of polymer after replacement with cellulase. In a particular embodiment of the present invention the detergent composition comprises more than 0.01% of polymer after replacement with cellulase. In a particular embodiment of the present invention the detergent composition comprises more than 1% of polymer after replacement with cellulase. In an even more particular embodiment of the present invention the detergent composition comprises 0 to 6% of polymer after replacement with cellulase, in a most particular embodiment of the present invention the detergent composition comprises 0 to 3% of polymer after replacement with cellulase.

In a particular embodiment of the present invention the powder detergent composition comprises 0 to 50% of builder after replacement with cellulase. In a more particular embodiment of the present invention the powder detergent compositions comprise 10 to 35% of builder after replacement with cellulase. In an even more particular embodiment of the present invention the powder detergent composition comprises 15 to 25% of builder after replacement with cellulase.

In a particular embodiment of the present invention the liquid detergent composition comprises 0 to 10% of builder after replacement with cellulase, in a more particular embodiment of the present invention the liquid detergent composition comprises 0 to 5% of builder before replacement with cellulase, in a most particular embodiment of the present invention the liquid detergent composition comprise less than 2% of builder after replacement with cellulase.

In a particular embodiment of the present invention the detergent composition comprises 0 to 35% of builder after replacement with cellulase. In a more particular embodiment of the present invention the detergent composition comprises 0 to 25% of builder after replacement with cellulase.

In a particular embodiment of the present invention the detergent composition comprises more than 1% of builder. In a particular embodiment of the present invention the detergent composition comprises more than 2% of builder. In a particular embodiment of the present invention the detergent composition comprises less than 35% of builder. In a more particular embodiment of the present invention the detergent composition comprises less than 25% of builder.

Amylases

In a particular embodiment of the present invention amylase is used to partly replace or fully replace one or more of the detergent components selected from the group consisting of surfactants, builders and polymers.

Any amylase (α and/or β) suitable for use in alkaline solutions can be used. Suitable amylases (α and/or β) include those of bacterial or fungal origin. Chemically modified or protein engineered variants are included. Amylases include, for example, α-amylases obtained from Bacillus, e.g. B. subtilis and B. licheniformis, in a particular embodiment the amylases are obtained from a special strain of B. licheniformis, described in more detail in GB 1,296,839.

In a particular embodiment of the present invention the amylase used to partly replace or fully replace builders in detergent compositions are alpha-amylases

In a particular embodiment of the present invention the amylase used to partly replace or fully replace builders in detergent compositions are amylases derived from Bacillus. In a more particular embodiment of the present invention the amylase used to partly replace or fully replace builders in detergent compositions are amylases derived from a microorganism selected from the group consisting of Bacillus licheniformis and Bacillus subtilis.

Examples of useful amylases are the variants described in WO 94/02597, WO 94/18314, WO 96/23873, and WO 97/43424, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

In a particular embodiment the alpha-amylase is derived from Bacillus sp. strains NCIB 12289, NCIB 12512, NCIB 12513 and DSM 9375. Especially preferred are the alpha-amylases shown in SEQ ID NOS 1 and 2 of WO 95/26397.

Commercially available amylases are NATALASE™, STAINZYME™, TERMAMYL™ ULTRA, DURAMYL™, TERMAMYL™, FUNGAMYL™ and BAN™ (Novozymes A/S), RAPIDASE™, PURASTAR™ and PURASTAR OXAM™ (from Genencor International Inc.).

The amylases can be incorporated in the detergent composition at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.002% to 0.02% of enzyme protein by weight of the composition.

In a particular embodiment of the present invention the amount of amylase added to the detergent composition to partly replace or fully replace surfactants and/or builders and/or polymers are 0.001 to 0.5% of enzyme protein by weight of the composition. In a more particular embodiment of the present invention the amount of amylase added to partly replace or fully replace surfactants and/or builders and/or polymers are 0.002 to 0.02%.

In a particular embodiment of the present invention the powder detergent composition comprises surfactants at a level of 0% to 30% after replacement of surfactants with amylase. In a more particular embodiment of the present invention the powder detergent composition comprises surfactants at a level of 0% to 20% after replacement of surfactants with amylase. In an even more particular embodiment of the present invention the powder detergent composition comprises surfactants at a level of 0 to 10% after replacement with amylase. In a most particular embodiment of the present Invention the powder detergent comprises surfactants at a level of 0 to 6% after replacement with amylase.

In a particular embodiment of the present invention the liquid detergent composition comprises 0% to 30% of surfactants after replacement of surfactants with amylase, in a more particular embodiment of the present invention the liquid detergent composition comprises 0% to 20% of surfactant after replacement with amylase, in an even more particular embodiment of the present invention the liquid detergent composition comprises 4% to 20% of surfactant after replacement with amylase, in a most particular embodiment of the present invention the liquid detergent composition comprises 5% to 15% of surfactant after replacement with amylase.

In a particular embodiment of the present invention the detergent composition comprise at least 0.01% by weight of surfactant. In a more particular embodiment of the present invention the detergent composition comprises at least 1% by weight of surfactant. In a most particular embodiment of the present invention the detergent composition comprises at least 3% by weight of surfactant. In a particular embodiment of the present invention the detergent composition comprise less than 30% by weight of surfactant. In a more particular embodiment of the present invention the detergent composition comprise less than 15% by weight of surfactant. In a most particular embodiment of the present invention the detergent composition comprise less than 10% by weight of surfactant.

In a particular embodiment of the present invention the detergent composition comprises less than 6% of polymer after replacement with amylase, in a more particular embodiment of the present invention the detergent composition comprises less than 4% of polymer after replacement with amylase. In a particular embodiment of the present invention the detergent composition comprises more than 0.01% of polymer after replacement with amylase. In a particular embodiment of the present invention the detergent composition comprises more than 1% of polymer after replacement with amylase. In an even more particular embodiment of the present invention the detergent composition comprises 0 to 6% of polymer after replacement with amylase. In a most particular embodiment of the present invention the detergent composition comprises 0 to 3% of polymer after replacement with amylase.

In a particular embodiment of the present invention the powder detergent composition comprises 0 to 50% of builder after replacement with amylase. In a more particular embodiment of the present invention the powder detergent compositions comprise 10 to 35% of builder after replacement with amylase. In an even more particular embodiment of the present invention the powder detergent composition comprises 15 to 25% of builder after replacement with amylase.

In a particular embodiment of the present invention the liquid detergent composition comprises 0 to 10% of builder after replacement with amylase, in a more particular embodiment of the present invention the liquid detergent composition comprises 0 to 5% of builder before replacement with amylase, in a most particular embodiment of the present invention the liquid detergent composition comprise less than 2% of builder after replacement with amylase.

In a particular embodiment of the present invention the detergent composition comprises 0 to 35% of builder after replacement with amylase. In a more particular embodiment of the present invention the detergent composition comprises 0 to 25% of builder after replacement with amylase.

In a particular embodiment of the present invention the detergent composition comprises more than 1% of builder. In a particular embodiment of the present invention the detergent composition comprises more than 2% of builder. In a particular embodiment of the present invention the detergent composition comprises less than 35% of builder. In a more particular embodiment of the present invention the detergent composition comprises less than 25% of builder.

Proteases

In a particular embodiment of the present invention proteases are used to partly replace or fully replace surfactants, builders and/or polymers in detergent compositions.

Any protease suitable for use in alkaline solutions can be used; suitable proteases include those of animal, vegetable or microbial origin. Microbial origin is preferred. Chemically or genetically modified or protein engineered variants are included. The protease may be a serine protease or a metallo protease, preferably an alkaline microbial protease or a trypsin-like protease. Examples of alkaline proteases are subtilisins, especially those derived from Bacillus, e.g., subtilisin Novo, subtilisin Carlsberg, subtilisin 309, subtilisin 147 and subtilisin 168 (described in WO 89/06279). Examples of trypsin-like proteases are trypsin (e.g. of porcine or bovine origin) and the Fusarium protease described in WO 89/06270 and WO 94/25583. In a particular embodiment the detergent composition comprises proteases derived from Bacillus, e.g. Bacillus Clausii, Bacillus Lentus, Bacillus halmapalus and B. amyloliquefaciens.

In a particular embodiment of the present invention the enzyme used to partly replace or fully replace builders in detergent compositions are proteases derived from Bacillus, particularly proteases derived from microorganisms selected from the group consisting of Bacillus Clausii, B. amyloliquefaciens, Bacillus halmapalus and B. lentus.

Examples of useful proteases are the variants described in WO 92/19729, WO 98/20115, WO 98/20116, and WO 98/34946, especially the variants with substitutions in one or more of the following positions: 27, 36, 57, 76, 87, 97, 101, 104, 120, 123, 167, 170, 194, 206, 218, 222, 224, 235 and 274.

Preferred commercially available protease enzymes include EVERLASE™, OVOZYME™, SAVOZYME™, SAVINASE™, ALCALASE™, SAVINASE™, PRIMASE™, DURALASE™, ESPERASE™, AND KANNASE™ (Novozymes A/S), MAXATASE™, MAXACAL™, MAXAPEM™, Opticlean™, PROPERASE™, PURAFECT™, PURAFECT OXP™, FNA™, FN2™, and FN3™, FN4™, BLAP (Genencor International Inc., DSM or Henkel).

Protease enzymes may be incorporated into the compositions in accordance with the invention at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.002% to 0.1% of enzyme protein by weight of the composition.

In a particular embodiment of the present invention the amount of protease added to the detergent composition to partly replace or fully replace surfactants and/or builders and/or polymers are 0.001 to 0.5% of enzyme protein by weight of the composition. In a more particular embodiment of the present invention the amount of protease added to partly replace or fully replace surfactants and/or builders and/or polymers are 0.002 to 0.1%.

In a particular embodiment of the present invention the powder detergent composition comprises surfactants at a level of 0% to 30% after replacement of surfactants with protease.

In a more particular embodiment of the present invention the powder detergent composition comprises surfactants at a level of 0% to 20% after replacement of surfactants with protease. In an even more particular embodiment of the present invention the powder detergent composition comprises surfactants at a level of 0 to 10% after replacement with protease. In a most particular embodiment of the present invention the powder detergent comprises surfactants at a level of 0 to 6% after replacement with protease.

In a particular embodiment of the present invention the liquid detergent composition comprises 0% to 30% of surfactants after replacement of surfactants with protease, in a more particular embodiment of the present invention the liquid detergent composition comprises 0% to 20% of surfactant after replacement with protease, in an even more particular embodiment of the present invention the liquid detergent composition comprises 4% to 20% of surfactant after replacement with protease, in a most particular embodiment of the present invention the liquid detergent composition comprises 5% to 15% of surfactant after replacement with protease.

In a particular embodiment of the present invention the detergent composition comprise at least 0.01% by weight of surfactant. In a more particular embodiment of the present invention the detergent composition comprises at least 1% by weight of surfactant. In a most particular embodiment of the present invention the detergent composition comprises at least 3% by weight of surfactant. In a particular embodiment of the present invention the detergent composition comprise less than 30% by weight of surfactant. In a more particular embodiment of the present invention the detergent composition comprise less than 15% by weight of surfactant. In a most particular embodiment of the present invention the detergent composition comprise less than 10% by weight of surfactant.

In a particular embodiment of the present invention the detergent composition comprises less than 6% of polymer after replacement with protease, in a more particular embodiment of the present invention the detergent composition comprises less than 4% of polymer after replacement with protease. In a particular embodiment of the present invention the detergent composition comprises more than 0.01% of polymer after replacement with protease. In a particular embodiment of the present invention the detergent composition comprises more than 1% of polymer after replacement with protease. In an even more particular embodiment of the present invention the detergent composition comprises 0 to 6% of polymer after replacement with protease, in a most particular embodiment of the present invention the detergent composition comprises 0 to 3% of polymer after replacement with protease.

In a particular embodiment of the present invention the powder detergent composition comprises 0 to 50% of builder after replacement with protease. In a more particular embodiment of the present invention the powder detergent compositions comprise 10 to 35% of builder after replacement with protease. In an even more particular embodiment of the present invention the powder detergent composition comprises 15 to 25% of builder after replacement with protease.

In a particular embodiment of the present invention the liquid detergent composition comprises 0 to 10% of builder after replacement with protease, in a more particular embodiment of the present invention the liquid detergent composition comprises 0 to 5% of builder before replacement with protease, in a most particular embodiment of the present invention the liquid detergent composition comprise less than 2% of builder after replacement with protease.

In a particular embodiment of the present invention the detergent composition comprises 0 to 35% of builder after replacement with protease. In a more particular embodiment of the present invention the detergent composition comprises 0 to 25% of builder after replacement with protease.

In a particular embodiment of the present invention the detergent composition comprises more than 1% of builder. In a particular embodiment of the present invention the detergent composition comprises more than 2% of builder. In a particular embodiment of the present invention the detergent composition comprises less than 35% of builder. In a more particular embodiment of the present invention the detergent composition comprises less than 25% of builder.

Oxidoreductases

In a particular embodiment of the present invention the enzyme used to replace component(s) of a detergent composition is an oxidoreductase (EC 1.-.-.-). In particular oxidoreductases may replace bleaches and/or dye transfer inhibiting agents and/or biocidal agents.

Particularly an oxidoreductase used to partly replace or fully replace such components in detergents is selected from the group consisting of peroxidases (EC 1.11.1.-), laccases (EC 1.10.3.2), oxidases (EC 1.1.3.4)] and lipoxygenases (EC 1.13.11.12). In particular the peroxidase is a haloperoxidase (EC 1.11.1.10), while the oxidase is a glucose oxidase or an aldose oxidase. The glucose oxidase may for example be the glucose oxidase from the product GLUZYME™ available from Novozymes A/S, DK.

Suitable oxidoreductases include those of plant, bacterial or fungal origin. Chemically or genetically modified variants are included.

In a particular embodiment the oxidoreductases are derived from microorganisms selected from the group consisting of Coprinus cinereus, Myceliophthora thermophila and Microdochium nirvale.

Both peroxidase and oxidase types of oxidoreductases are used for “solution bleaching”, i.e. to prevent transfer of a textile dye from a dyed fabric to another fabric when said fabrics are washed together in a wash liquor, preferably together with an enhancing agent as described in e.g. WO 94/12621 and WO 95/01426.

Oxidoreductase enzymes may be incorporated in the detergent composition at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.01% to 0.2% of enzyme protein by weight of the composition.

In a particular embodiment of the present invention the amount of oxidoreductase added to the detergent composition is 0.001 to 0.5% of enzyme protein by weight of the composition. In a more particular embodiment of the present invention the amount of oxidoreductase is 0.01 to 0.2%.

In a particular embodiment the detergent composition comprises 0 to 15% of bleach after replacement with enzymes. In a more particular embodiment the detergent composition comprises 0 to 8% of bleach after replacement with oxidoreductase. In a particular embodiment the detergent composition comprises less than 8% of bleach after replacement with oxidoreductase.

Mixtures of Enzymes:

The choice of enzymes to be added to a detergent composition in view of the present invention depends on what detergent components need to be replaced. In some cases the detergent already comprise enzymes which provide improved detergency on certain soiling compared to surfactants, builders polymers, and additional enzyme(s) have to be added to replace the detergent components. In some cases it is only necessary to add one enzyme to the detergent composition to partly or fully replace one or more of the mentioned detergent components, but in most cases it is beneficial to combine two or more enzymes to be able to partly replace or fully replace one or more of the surfactants, builders, polymers and bleaches.

The actual composition of a detergent varies, depending on the kind of soling it is designed to clean and how well it performs. Therefore the detergent components which advantageously may be fully or partly replaced by enzymes in accordance with the invention also varies. Hence for different detergent compositions different enzymes or mixtures thereof may be suitable to fully or partly replace detergent components.

In some detergent compositions the replacement of detergent components gives a better result if a lipase is used in combination with other enzymes.

In a particular embodiment of the present invention the detergent composition comprises a lipase and one or more enzymes selected from the group consisting of cellulase, protease, amylase and oxidoreductase.

In other detergent compositions the replacement of detergent components gives a better result if a protease is used in combination with other enzymes.

In a particular embodiment of the present invention the detergent composition comprises protease and one or more enzymes selected from the group consisting of cellulase, lipase, amylase and oxidoreductase.

The inventors have found that a combination of enzymes, compared to just using one enzyme, often give better results when replacing a detergent component. Particularly the combination of lipase, cellulase, amylase and protease has proven to be particularly effective. Especially if more than one detergent components are to be partly or fully replaced e.g. surfactant and builder, it is beneficial to combine two or more enzymes.

In a particular embodiment of the present invention a detergent composition comprise a mixture of two or more enzymes selected from the group consisting of lipase, cellulase, mannanase, pectinase, amylase, protease and oxidoreductase to partly replace or fully replace a number of detergent components selected from the group consisting of surfactants, builders, polymers and bleaches.

In a particular embodiment of the present invention a mixture of enzymes, in particular two or more enzymes, selected from the group consisting of lipase, cellulase, amylase, mannanase, pectinase, protease and oxidoreductase is used in the detergent composition to partly replace or fully replace a number of detergent components selected from the group consisting of surfactants, builders, polymers and bleaches.

In a particular embodiment of the present invention the detergent composition comprise lipase and cellulase to partly replace or fully replace one or more detergent components selected from the group consisting of surfactant, builder and polymer.

In a particular embodiment of the present invention the detergent composition comprise lipase, cellulase, amylase and protease to partly replace or fully replace one or more detergent components selected from the group consisting of surfactant, builder and polymer.

In a particular embodiment of the present invention the detergent composition comprise lipase, amylase and protease to partly replace or fully replace one or more detergent components selected from the group consisting of surfactant, builder and polymer. In a particular embodiment of the present invention the detergent composition comprise lipase, cellulase, and protease to partly replace or fully replace one or more detergent components selected from the group consisting of surfactant, builder and polymer.

In a particular embodiment of the present invention the detergent composition comprise lipase, and protease to partly replace or fully replace one or more detergent components selected from the group consisting of surfactant, builder and polymer.

In a particular embodiment of the present invention the detergent composition comprise lipase, amylase and oxidoreductases to partly replace or fully replace one or more detergent components selected from the group consisting of surfactant, bleaches, builder and polymer.

In a particular embodiment of the present invention the detergent composition comprise lipase, cellulase, and oxidoreductase to partly replace or fully replace one or more detergent components selected from the group consisting of surfactant, builder, bleaches and polymer.

The enzymes may be included in a detergent composition by adding separate additives containing one or more enzymes, or by adding a combined additive comprising two or more of these enzymes. A detergent additive of the invention, i.e. a separate additive or a combined additive, may be formulated so as to comprise different enzymes.

The detergent composition of the invention may be in any convenient dry form, e.g., a bar, a tablet, a powder, a granule or a paste. It may also be a liquid detergent, in particular nonaqueous liquid detergent.

The enzymes are incorporated in the detergent composition at a level of at least 0.00001% of enzyme protein by weight of the composition. In a particular embodiment of the present invention the enzymes are incorporated in the detergent composition at a level of at least 0.0001% of enzyme protein by weight of the composition. In a more particular embodiment of the present invention the enzymes are incorporated in the detergent composition at a level of at least 0.001% of enzyme protein by weight of the composition.

In a particular embodiment of the present invention the enzyme is incorporated in the detergent composition at a level of less than 99% of enzyme protein by weight of the composition. In a more particular embodiment the enzyme is incorporated in the detergent composition at a level of less than 80% of enzyme protein by weight of the composition. In an even more particular embodiment the enzyme is incorporated in the detergent composition at a level of less than 50% of enzyme protein by weight of the composition. In an even more particular embodiment the enzyme is incorporated in the detergent composition at a level of less than 20% of enzyme protein by weight of the composition.

The enzymes may be incorporated in the detergent composition at a level of from 0.00001% to 2% of enzyme protein by weight of the composition, preferably at a level of from 0.0001% to 1% of enzyme protein by weight of the composition, more preferably at a level of from 0.001% to 0.5% of enzyme protein by weight of the composition, even more preferably at a level of from 0.01% to 0.2% of enzyme protein by weight of the composition.

In a particular embodiment of the present invention any enzyme, may be added in an amount corresponding to 0.001-100 mg of enzyme protein per litre of wash liquor to the detergent composition, in a more particular embodiment any enzyme may be added in an amount corresponding to 0.01-10 mg of enzyme protein per litre of wash liquor to the detergent composition, in a most particular embodiment any enzyme may be added in an amount corresponding to 0.1-1 mg of enzyme protein per litre of wash liquor.

The enzyme(s) of the detergent composition of the invention may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic add derivative such as 4-formylphenyl boronic add, and the composition may be formulated as described in e.g. WO 92/19709 and WO 92/19708.

The detergent composition of the present invention may in an embodiment of the invention besides the enzymes, mentioned vide supra, comprise other enzyme(s) which add additional detergency and/or provide fabric care benefits (laundry) but may also be able of replacing detergent components. Such enzymes include mannanase and pectate/pectin lyases, cutinases, cyclodextrin glucosyltransferases, phytases, and expansins.

Mannases: Any mannanase suitable for use in alkaline solutions can be used. Suitable mannanases include those of bacterial or fungal origin. Chemically or genetically modified variants are included.

In a preferred embodiment the mannanase is derived from a strain of the genus Bacillus, especially Bacillus sp. 1633 disclosed in positions 31-330 of SEQ ID NO:2 or in SEQ ID NO: 5 of WO 99/64619 or Bacillus agaradhaerens, for example from the type strain DSM 8721. In a more preferred embodiment of the present invention the mannanase is derived from an alkalophilic bacillus.

An example of a commercially available mannanase is MANNAWAY™ (available from Novozymes A/S).

Pectate lyase: Any pectate lyase suitable for use in alkaline solutions can be used. Suitable pectate lyases include those of bacterial or fungal origin. Chemically or genetically modified variants are included.

In a preferred embodiment the pectate lyase is derived from a strain of the genus Bacillus, especially a strain of Bacillus subtilis, especially Bacillus subtilis DSM14218 disclosed in SEQ ID NO:2 or a variant thereof disclosed in Example 6 of WO 02/092741. In a more preferred embodiment of the present invention the pectate lyase is derived from Bacillus licheniformis.

Surfactants

One object of the invention is to replace surfactants in detergent compositions, but we have found that in some detergent compositions it is difficult to replace all surfactant present in the formulation and still obtain a satisfactorily result. Therefore the detergent composition comprises surfactants but in a decreased amount compared to conventional detergent compositions.

The surfactant is typically present in detergent compositions at a level from 0.1% to 60% by weight.

In a particular embodiment of the present invention the detergent composition comprises surfactants at a level of 0 to 30% or 0.2 to 30% after replacement of surfactants with enzyme. In a more particular embodiment of the present invention the detergent composition comprises surfactants at a level of 0 to 20% or 0.2 to 20% after replacement of surfactants with enzyme. In an even more particular embodiment of the present invention the detergent composition comprises surfactants at a level of 0 to 10% or 0.2 to 10% after replacement with enzyme. In a most particular embodiment of the present invention the detergent composition comprises surfactants at a level of 0 to 6% or 0.2 to 6% after replacement with enzyme.

In a particular embodiment of the present invention the liquid detergent composition comprises 0% to 30% of surfactants after replacement of surfactants with enzyme, in a more particular embodiment of the present invention the liquid detergent composition comprises 0% to 20% of surfactant after replacement with enzyme, in an even more particular embodiment of the present invention the liquid detergent composition comprises 4% to 20% of surfactant after replacement with enzyme, in a most particular embodiment of the present invention the liquid detergent composition comprises 5% to 15% of surfactant after replacement with enzyme.

In a particular embodiment of the present invention the detergent composition comprise at least 0.01% by weight of surfactant. In a more particular embodiment of the present invention the detergent composition comprises at least 1% by weight of surfactant. In a most particular embodiment of the present invention the detergent composition comprises at least 3% by weight of surfactant. In a particular embodiment of the present invention the detergent composition comprise less than 30% by weight of surfactant. In a more particular embodiment of the present invention the detergent composition comprise less than 15% by weight of surfactant. In a most particular embodiment of the present invention the detergent composition comprise less than 10% by weight of surfactant.

In some detergent compositions different types of surfactants are present and in these detergent compositions it might only be possible to replace some of the different surfactants present partly or fully with enzymes.

In a particular embodiment of the present invention the detergent composition comprise 0.2 to 4% of enzyme replaceable surfactant after partly replacement with enzymes. In a more particular embodiment of the present invention the detergent composition comprise 8 to 25% of enzyme replaceable surfactant after partly replacement with enzymes.

In another particular embodiment of the present invention the detergent composition comprises one or more surfactants which can not be replaced with enzymes and 0 to 30% of other types of surfactants which have been replaced with enzymes.

The detergent composition may comprise one or more surfactants which may be anionic including semi-polar and/or nonionic and/or cationic and/or zwitterionic.

All surfactants mentioned below are surfactants which are found in conventional detergent compositions and can be found in the detergent composition of the present invention and can be a target for partly or fully replacement with enzymes.

Anionic Surfactants

Anionic surfactants are well known to those skilled in the art. Many suitable surface active compounds are available and fully described in the literature, for example, in “Surface-Active Agents and Detergents”, Volumes I and II, by Schwartz, Perry and Berch.

Examples include linear alkylbenzene sulfonates, primary and secondary alkyl sulphates, particularly C₈-C₁₅ primary alkyl sulphates; alkyl ether sulphate; alkyl ethoxylate sulphates; olefin sulfonates; alkyl xylene sylphonates; dialkyl sulfosuccinates; and fatty acid ester sulfonates. Sodium salts are generally preferred.

Preferably the anionic surfactant is linear alkylbenzene sulfonate or primary alcohol sulphate. More preferably the anionic surfactant is linear alkylbenzene sulfonate.

Highly preferred anionic surfactants include alkyl alkoxylated sulfate surfactants. Examples hereof are water soluble salts or acids of the formula RO(A)ₘSO3M wherein R is an unsubstituted C₁₀-C₂₄ alkyl or hydroxyalkyl group having a C₁₀-C₂₄ alkyl component, preferably a C₁₂-C₂₀ alkyl or hydro-xyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl, trimethyl-ammonium cations and quaternary ammonium cations such as tetramethylammonium and dimethyl piperidinium cations and those derived from alkylamines such as ethylamine, diethylamine, triethylamine, mixtures thereof, and the like. Exemplary surfactants are C₁₂-C₁₈ alkyl polyethoxylate (1.0) sulfate (C₁₂-C₁₈E(1.0)M), C₁₂-C₁₈ alkyl polyethoxylate (2.25) sulfate (C₁₂-C₁₈(2.25)M, and C₁₂-C₁₈ alkyl polyethoxylate (3.0) sulfate (C₁₂-C₁₈E(3.0)M), and C₁₂-C₁₈ alkyl polyethoxylate (4.0) sulfate (C₁₂-C₁₈E(4.0)M), wherein M is conveniently selected from sodium and potassium.

Suitable anionic surfactants to be used are alkyl ester sulfonate surfactants including linear esters of C₈-C₂₀ carboxylic acids (i.e., fatty acids) which are sulfonated with gaseous SO₃ according to “The Journal of the American Oil Chemists Society”, 52 (1975), pp. 323-329. Suitable starting materials would include natural fatty substances as derived from tallow, palm oil, etc.

The preferred alkyl ester sulfonate surfactant, especially for laundry applications, comprises alkyl ester sulfonate surfactants of the structural formula: 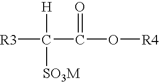
wherein R³ is a C₈-C₂₀ hydrocarbyl, preferably an alkyl, or combination thereof, R⁴ is a C₁-C₆ hydrocarbyl, preferably an alkyl, or combination thereof, and M is a cation which forms a water soluble salt with the alkyl ester sulfonate. Suitable salt-forming cations include metals such as sodium, potassium, and lithium, and substituted or unsubstituted ammonium cations, such as monoethanolamine, diethanolamine, and triethanolamine. Preferably, R³ is C₁₀-C₁₆ alkyl, and R⁴ is methyl, ethyl or isopropyl. Especially preferred are the methyl ester sulfonates wherein R³ is C₁₀-C₁₆ alkyl.

Other suitable anionic surfactants include the alkyl sulfate surfactants which are water soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g. sodium, potassium, lithium), or ammonium or substituted ammonium (e.g. methyl-, dimethyl-, and trimethyl ammonium cations and quaternary ammonium cations such as tetramethylammonium and dimethyl piperidinium cations and quaternary ammonium cations derived from alkylamines such as ethylamine, diethylamine, triethylamine, and mixtures thereof, and the like). Typically, alkyl chains of C₁₂-C₁₆ are preferred for lower wash temperatures (e.g. below about 50° C.) and C₁₆-C₁₈ alkyl chains are preferred for higher wash temperatures (e.g. above about 50° C.).

Other anionic surfactants used for detersive purposes in the laundry detergent compositions are salts (including, for example, sodium, potassium, ammonium, and substituted ammonium salts such as mono- di- and triethanolamine salts) of soap, C₈-C₂₂ primary or secondary alkanesulfonates, C₈-C₂₄ olefinsulfonates, sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl glycerol sulfonates, fatty acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinates (especially saturated and unsaturated C₁₂-C₁₈ monoesters) and diesters of sulfosuccinates (especially saturated and unsaturated C₈-C₁₂ diesters), acyl sarcosinates, sulfates of alkylpolysaccharides such as the sulfates of alkylpolyglucoside (the nonionic nonsulfated compounds being described below), branched primary alkyl sulfates, and alkyl polyethoxy carboxylates such as those of the formula RO(CH₂CH₂O)ₖ—CH₂COO-M+ wherein R is a C₈-C₂₂ alkyl, k is an integer from 1 to 10, and M is a soluble salt forming cation. Resin acids and hydrogenated resin acids are also suitable, such as rosin, hydrogenated rosin, and resin acids and hydrogenated resin adds present in or derived from tall oil.

Alkylbenzene sulfonates are highly preferred. Especially preferred are linear (straight-chain) alkyl benzene sulfonates (LAS) wherein the alkyl group preferably contains from 10 to 18 carbon atoms.

Further examples are described in “Surface Active Agents and Detergents” (Vol. I and II by Schwartz, Perrry and Berch). A variety of such surfactants are also generally disclosed in U.S. Pat. No. 3,929,678, (Column 23, line 58 through Column 29, line 23, herein incorporated by reference).

Nonionic Surfactants

Nonionic surfactants include ethoxylated aliphatic alcohol; C₈-C₁₅ and degrees of ethoxylation from 0-10 moles.

Polyethylene, polypropylene, and polybutylene oxide condensates of alkyl phenols are suitable for use as nonionic surfactants, with the polyethylene oxide condensates being preferred. These compounds include the condensation products of alkyl phenols having an alkyl group containing from about 6 to about 14 carbon atoms, preferably from about 8 to about 14 carbon atoms, in either a straight chain or branched-chain configuration with the alkylene oxide. In a preferred embodiment, the ethylene oxide is present in an amount equal to from about 2 to about 25 moles, more preferably from about 3 to about 15 moles, of ethylene oxide per mole of alkyl phenol. Commercially available nonionic surfactants of this type include Igepal™ CO-630, marketed by the GAF Corporation; and Triton™ X45, X-114, X-100 and X-102, all marketed by the Rohm & Haas Company. These surfactants are commonly referred to as alkylphenol alkoxylates (e.g., alkyl phenol ethoxylates).

The condensation products of primary and secondary aliphatic alcohols with about 1 to about 25 moles of ethylene oxide are suitable for use as nonionic surfactant. The alkyl chain of the aliphatic alcohol can either be straight or branched, primary or secondary, and generally contains from about 8 to about 22 carbon atoms. Preferred are the condensation products of alcohols having an alkyl group containing from about 8 to about 20 carbon atoms, more preferably from about 10 to about 18 carbon atoms, with from about 2 to about 10 moles of ethylene oxide per mole of alcohol. About 2 to about 7 moles of ethylene oxide and most preferably from 2 to 5 moles of ethylene oxide per mole of alcohol are present in said condensation products. Examples of commercially available nonionic surfactants of this type Include Tergitol™ 15-S-9 (The condensation product of C₁₁-C₁₅ linear alcohol with 9 moles ethylene oxide), Tergitol™ 24-L-6 NMW (the condensation product of C₁₂-C₁₄ primary alcohol with 6 moles ethylene oxide with a narrow molecular weight distribution), both marketed by Union Carbide Corporation; Neodol™ 45-9 (the condensation product of C₁₄-C₁₅ linear alcohol with 9 moles of ethylene oxide), Neodol™ 23-3 (the condensation product of C₁₂-C₁₃ linear alcohol with 3.0 moles of ethylene oxide), Neodol™ 45-7 (the condensation product of C₁₄-C₁₅ linear alcohol with 7 moles of ethylene oxide), Neodol™ 45-5 (the condensation product of C₁₄-C₁₅ linear alcohol with 5 moles of ethylene oxide) marketed by Shell Chemical Company, Kyro™ EOB (the condensation product of C₁₃-C₁₅ alcohol with 9 moles ethylene oxide), marketed by The Procter & Gamble Company, and Genapol LA 050 (the condensation product of C₁₂-C₁₄ alcohol with 5 moles of ethylene oxide) marketed by Hoechst. Preferred range of HLB in these products is from 8-11 and most preferred from 8-10.

Also used as nonionic surfactant are alkylpolysaccharides disclosed in U.S. Pat. No. 4,565,647, having a hydrophobic group containing from about 6 to about 30 carbon atoms, preferably from about 10 to about 16 carbon atoms and a polysaccharide, e.g. a polyglycoside, hydrophilic group containing from about 1.3 to about 10, preferably from about 1.3 to about 3, most preferably from about 1.3 to about 2.7 saccharide units. Any reducing saccharide containing 5 or 6 carbon atoms can be used, e.g., glucose, galactose and galactosyl moieties can be substituted for the glucosyl moieties (optionally the hydrophobic group is attached at the 2-, 3-, 4-, etc. positions thus giving a glucose or galactose as opposed to a glucoside or galactoside). The intersaccharide bonds can be, e.g., between the one position of the additional saccharide units and the 2-, 3-, 4-, and/or 6-positions on the preceding saccharide units.

The preferred alkylpolyglycosides have the formula:
R²O(CₙH₂ₙO)ₜ(glycosyl)ₓ
wherein R² is selected from the group consisting of alkyl, alkylphenyl, hydroxyalkyl, hydroxyalkylphenyl, and mixtures thereof in which the alkyl groups contain from about 10 to about 18, preferably from about 12 to about 14, carbon atoms; n is 2 or 3, preferably 2; t is from 0 to about 10, preferably 0; and x is from about 1.3 to about 10, preferably from about 1.3 to about 3, most preferably from about 1.3 to about 2.7. The glycosyl is preferably derived from glucose. To prepare these compounds, the alcohol or alkylpolyethoxy alcohol is formed first and then reacted with glucose, or a source of glucose, to form the glucoside (attachment at the 1-position). The additional glycosyl units can then be attached between their 1-position and the preceding glycosyl units 2-, 3-, 4-, and/or 6-position, preferably predominantly the 2-position.

The condensation products of ethylene oxide with a hydrophobic base formed by the condensation of propylene oxide with propylene glycol are also used as additional nonionic surfactant system. The hydrophobic portion of these compounds will preferably have a molecular weight from about 1500 to about 1800 and will exhibit water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product, which corresponds to condensation with up to about 40 moles of ethylene oxide. Examples of compounds of this type include certain of the commercially available Pluronic™ surfactants, marketed by BASF.

Also suitable for use as nonionic surfactant system, are the condensation products of ethylene oxide with the product resulting from the reaction of propylene oxide and ethylenediamine. The hydrophobic moiety of these products consists of the reaction product of ethylenediamine and excess propylene oxide, and generally has a molecular weight of from about 2500 to about 3000. This hydrophobic moiety is condensed with ethylene oxide to the extent that the condensation product contains from about 40% to about 80% by weight of polyoxyethylene and has a molecular weight of from about 5,000 to about 11,000. Examples of this type of nonionic surfactant include certain of the commercially available Tetronic™ compounds, marketed by BASF.

Preferred for use as nonionic surfactant systems are polyethylene oxide condensates of alkyl phenols, condensation products of primary and secondary aliphatic alcohols with from about 1 to about 25 moles of ethyleneoxide, alkylpolysaccharides, and mixtures hereof. Most preferred are C₈-C₁₄ alkyl phenol ethoxylates having from 3 to 15 ethoxy groups and C₈-C₁₈ alcohol ethoxylates (preferably C₁₀ avg.) having from 2 to 10 ethoxy groups, and mixtures thereof.

Highly preferred nonionic surfactants are polyhydroxy fatty acid amide surfactants of the formula: 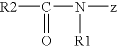
wherein R¹ is H, or R¹ is C₁₋₄ hydrocarbyl, 2-hydroxyethyl, 2-hydroxypropyl or a mixture thereof, R² is C₅₋₃₁ hydrocarbyl, and Z is a polyhydroxyhydrocarbyl having a linear hydrocarbyl chain with at least 3 hydroxyls directly connected to the chain, or an alkoxylated derivative thereof. Preferably, R¹ is methyl, R² is straight C₁₁₋₁₅ alkyl or C₁₆₋₁₈ alkyl or alkenyl chain such as coconut alkyl or mixtures thereof, and Z is derived from a reducing sugar such as glucose, fructose, maltose or lactose, in a reductive amination reaction.
Cationic Surfactants

The detergent composition can further comprise cationic surfactants. Cationic detersive surfactants used are those having one long-chain hydrocarbyl group. Examples of such cationic surfactants include the ammonium surfactants such as alkyltrimethylammonium halogenides, and those surfactants having the formula:
[R²(OR³)_{y}][R⁴(OR³)_{y}]₂R⁶N+X—
wherein R² is an alkyl or alkyl benzyl group having from about 8 to about 18 carbon atoms in the alkyl chain, each R³ is selected form the group consisting of —CH₂CH₂—, —CH₂CH(CH₃)—, —CH₂CH(CH₂OH)—, —CH₂CH₂CH₂—, and mixtures thereof; each R⁴ is selected from the group consisting of C₁-C₄ alkyl, C₁-C₄ hydroxyalkyl, benzyl ring structures formed by joining the two R⁴ groups, —CH₂CHOHCHOHCOR⁶CHOHCH₂OH, wherein R⁶ is any hexose or hexose polymer having a molecular weight less than about 1000, and hydrogen when y is not 0; R⁵ is the same as R⁴ or is an alkyl chain, wherein the total number of carbon atoms or R² plus R⁵ is not more than about 18; each y is from 0 to about 10, and the sum of the y values is from 0 to about 15; and X is any compatible anion.

Highly preferred cationic surfactants are the water soluble quaternary ammonium compounds useful in the present composition having the formula:
R₁R₂R₃R₄N⁺X⁻ (i)
wherein R₁ is C₈-C₁₆ alkyl, each of R₂, R₃ and R₄ is independently C₁-C₄ alkyl, C₁-C₄ hydroxy alkyl, benzyl, and —(C₂H₄₀)ₓH where x has a value from 2 to 5, and X is an anion. Not more than one of R₂, R₃ or R₄ should be benzyl.

The preferred alkyl chain length for R₁ is C₁₂-C₁₅, particularly where the alkyl group is a mixture of chain lengths derived from coconut or palm kernel fat or is derived synthetically by olefin build up or OXO alcohols synthesis.

Preferred groups for R₂R₃ and R₄ are methyl and hydroxyethyl groups and the anion X may be selected from halide, methosulphate, acetate and phosphate ions.

Examples of suitable quaternary ammonium compounds of formulae (i) for use herein are:

coconut trimethyl ammonium chloride or bromide; coconut methyl dihydroxyethyl ammonium chloride or bromide; decyl triethyl ammonium chloride; decyl dimethyl hydroxyethyl ammonium chloride or bromide; C₁₂₋₁₅ dimethyl hydroxyethyl ammonium chloride or bromide; coconut dimethyl hydroxyethyl ammonium chloride or bromide; myristyl trimethyl ammonium methyl sulphate; lauryl dimethyl benzyl ammonium chloride or bromide; lauryl dimethyl (ethenoxy)₄ ammonium chloride or bromide; choline esters (compounds of formula (i) wherein R₁ is CH₂—CH₂—O—CO—C₁₂₋₁₄ alkyl and R₂R₃R₄ are methyl); di-alkyl imidazolines [compounds of formula (i)].

Other cationic surfactants used are also described in U.S. Pat. No. 4,228,044 and in EP 000 224.

Ampholytic Surfactants

The detergent composition can further comprise ampholytic surfactants. These surfactants can be broadly described as aliphatic derivatives of secondary or tertiary amines, or aliphatic derivatives of heterocyclic secondary and tertiary amines in which the aliphatic radical can be straight- or branched-chain. One of the aliphatic substituents contains at least about 8 carbon atoms, typically from about 8 to about 18 carbon atoms, and at least one contains an anionic water-solubilizing group, e.g. carboxy, sulfonate, sulfate. See U.S. Pat. No. 3,929,678 (column 19, lines 18-35) for examples of ampholytic surfactants.

Zwitterionic Surfactants

Zwitterionic surfactants are also used in detergent compositions especially within laundry. These surfactants can be broadly described as derivatives of secondary and tertiary amines, derivatives of heterocyclic secondary and tertiary amines, or derivatives of quaternary ammonium, quaternary phosphonium or tertiary sulfonium compounds. See U.S. Pat. No. 3,929,678 (column 19, line 38 through column 22, line 48) for examples of zwitterionic surfactants.

Semi-Polar Surfactants

Semi-polar nonionic surfactants are a special category of nonionic surfactants which include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety from about 10 no to about 18 carbon atoms and a moiety selected from the group consisting of alkyl and hydroxyalkyl moieties of from about 1 to about 3 carbon atoms.

Semi-polar nonionic detergent surfactants include the amine oxide surfactants having the formula: 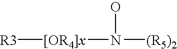
wherein R³ is an alkyl, hydroxyalkyl, or alkyl phenyl group or mixtures thereof containing from about 8 to about 22 carbon atoms; R⁴ is an alkylene or hydroxyalkylene group containing from about 2 to about 3 carbon atoms or mixtures thereof; x is from 0 to about 3: and each R⁵ is an alkyl or hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₂ alkoxy ethyl dihydroxy ethyl amine oxides.

The surfactant is formulated to be compatible with enzyme components present in the composition. In liquid or gel compositions the surfactant is most preferably formulated in such a way that it promotes, or at least does not degrade, the stability of any enzyme in these compositions.

The detergent compositions of the present invention may also contain cationic, ampholytic, zwitterionic, and semi-polar surfactants, as well as the nonionic and/or anionic surfactants other than those already described herein and be a target for replacement.

In a particular embodiment of the present invention the surfactant in the detergent composition which has been fully replaced or partly replaced is selected from the group consisting of linear alkylbenzene sulfonates, alkyl sulfates with alcohol chain lengths of 9 to 15, alkylethoxylate sulfates with alcohol chain lengths from 9 to 15 and degrees of ethoxylation from 0 to 10 moles, and alkylethoxylates with alcohol chain lengths from 9 to 15 and degrees of ethoxylation from 0 to 10 moles, N,N-dimethyltetradecane-1-amine-N-oxide, distearyidimethylammonium chloride and fatty acid glucamide.

In a particular embodiment of the present invention the surfactants which are enzyme replaceable is selected from the group consisting of linear alkylbenzene sulfonates, alkyl sulfates with alcohol chain lengths of 9 to 15, alkylethoxylate sulfates with alcohol chain lengths from 9 to 15 and degrees of ethoxylation from 0 to 10 moles, and alkylethoxylates with alcohol chain lengths from 9 to 15 and degrees of ethoxylation from 0 to 10 moles, N,N-dimethyltetradecane-1-amine-N-oxide, distearyldimethylammonium chloride and fatty acid glucamid.

Detergents Comprising Surfactant Systems Optimized for High Levels of Enzymes

In detergent compositions of the invention comprising at least 0.00001% to 80% of enzyme protein by weight, in a particular at least 0.0001% to 80% of enzyme protein by weight, more particular at least 0.001% to 80% of enzyme protein by weight, more particular at least 0.01% to 80% of enzyme protein by weight, more particular at least 0.1% to 80% of enzyme protein by weight, more particular at least 1% to 80% of enzyme protein by weight, more particular at least 10% to 80% of enzyme protein by weight, such as 0.1% to 10% of enzyme protein by weight, e.g. 0.1% to 5% by weight, in particularly enzymes or mixtures of enzymes that renders water-soluble degradation products; in particular lipolytic enzymes or mixtures comprising such, the detergent system may be designed so that the enzyme wash performance is improved in a cost-efficient way.

Improvement of enzyme wash performance may be achieved by using detergent compositions that facilitate an increased effective enzyme affinity for surface-associated or bound substrates. It has surprisingly been found that such facilitation can be achieved by modulating the compositions and concentrations of surface-active ingredients in particular the surfactant system with respect to electrostatic interactions, wetting and/or suspension properties for an improved interaction/cooperation with the enzyme system. Other ingredients or conditions may in combination with the surfactant system also have some effect on the facilitation of enzyme wash performance such as polymers, bleach activators, pH, salt, builders, bleach agents, and/or temperature/time profile.

It has further been found that to improve the performance of the enzymes in detergent compositions of the invention by choosing a surfactant system rendering the effective affinities of the enzymes for the substrate containing surfaces as high as possible, the association rate constants should be as high as possible, whereas the dissociation rate constants should preferably be within a certain range for the chosen enzymes and wash conditions. The effective affinities were found to be at least partially governed by the competition of enzyme association between different substrate surfaces in the wash system, so that the substrate surfaces of soiling on fabrics were competing for the enzymes with non-soil substrate surfaces such as micelles, soil-release polymers and particulates, i.e. substrates for which interaction with the enzyme did not add to the washing performance. In case of e.g. lipases, it is also important to optimize the dissociation rate constants in the wash system in order to reduce any generation of odor from short-chain lipid reaction products after the wash process.

In identification of surfactants systems and other detergent constituents and wash parameters improving the enzyme washing performance model washing like terg-o-tometer, launder-o-meter as described above and testing as described in WO 02/42740, where the substrates may contain a dye and multi-variable statistical analysis may be employed. SPR (Surface Plasmon Resonance) may also be employed to characterize surface binding and activity for the wash system in order to test efficiency of detergent composition and wash conditions. In addition to SPR, QCM-D (Quartz Crystal Micro Balance with dissipation mode), ellipsometry, and other surface spectroscopies may be used.

It has been found that central parameters of the surfactant system to be evaluated in relation to the enzyme performance include: electrostatic interactions (ratios of anionic/nonionic/zwitterionic/cationic surfactants), wetting (defined by the critical ad-micellar concentration, CAC, determined e.g. in a standard fabric wetting experiment) and suspension (defined by the critical micellar concentration, CMC, determined e.g. by tensiometry).

Surfactant wetting is beneficial in order to speed up hydration of fabrics and stains, and to liberate soil and products from enzymatic activity, while solubilization or suspension is required, e.g., for cleaning of particulate soils.

It has further been found that surfactants with mainly wetting properties (high CMC) are short-chain surfactants (C₆-C₁₁ in hydrocarbon chains—or equivalent for polymeric chains). Longer-chain surfactants have lower CMC and better suspending capacity. The latter type of surfactants would at large concentrations create micelles, which represent a potentially competing surface for enzyme binding. For example for lipolytic enzymes it has further been found that long-chain non-ionic surfactants significantly inhibits the performance of a lipolytic enzyme on lipid soilings on textiles.

Resulting from the findings above the invention provides a detergent composition comprising 0.00001% to 80% of enzyme protein by weight said composition having an improved enzyme detergency by comprising a surfactant system having a ratio CAC:CMC of less than 0.95 in a washing liquor at Standard European conditions and/or Standard North American conditions and/or Standard Asia-Pacific conditions.

As defined above Standard European conditions includes dosing 5 g/l detergent composition in deionized water at a hardness of 14°dH (3:1 Ca:Mg) and an NaHCO₃ concentration of 5 mM using at 40° C.

As defined above Standard North American conditions includes dosing 1 g/l detergent composition in water at a hardness of 6°dH (2:1 Ca:Mg) and an NaHCO₃ concentration of 2,14 mM at 32° C.

As defined above Standard Asia-Pacific conditions includes dosing 0,5 g/L or 0,67 g/L detergent composition in deionized water at a hardness of 3°dH (2:1 Ca:Mg) and an NaHCO₃ concentration of 1,07 mM at 20° C.

In a particular embodiment the ratio CAC:CMC should be less than 0.90; particularly less than 0,85; particularly less than 0,80; particularly less than 0,75; particularly less than 0,70; particularly less than 0,65; particularly less than 0,60; particularly less than 0,55; particularly less than 0,50; particularly less than 0,45; particularly less than 0,40; particularly less than 0,35; particularly less than 0,30; particularly less than 0,25; particularly less than 0,20; particularly less than 0,15; particularly less than 0,10.

In a particular embodiment the overall charge of the micelles and emulsion-particles in wash solution, prepared from said detergent compositions having a ratio CAC:CMC of less than 0.95, is negative.

In this context the invention also provides the use of a surfactant system having a CAC/CMC<0.95 in a washing liquor at Standard European conditions and/or Standard North American conditions and/or Standard Asia-Pacific conditions for improving the enzyme detergency.

Also resulting from the findings above regarding electrostatic interactions the invention further provides a detergent composition comprising 0.00001% to 80% of enzyme protein by weight of which at least 0.05% by weight is a lipolytic enzyme said composition having an improved lipolytic enzyme detergency by comprising a surfactant system wherein nonionic surfactant constitutes less than 50% w/w of the total surfactant and the critical micellar concentration of the surfactant system is above 0.1 Mm in a washing liquor at Standard European conditions and/or Standard North American conditions and/or Standard Asia-Pacific conditions.

In this context the invention also provides the use of a surfactant system wherein non-ionic surfactant constitutes less than 50% w/w of the total surfactant and the critical micellar concentration of the surfactant system is above 0.1 Mm in a washing liquor at Standard European conditions and/or Standard North American conditions and/or Standard Asia-Pacific conditions for improving the lipolytic enzyme detergency.

In a particular embodiment the detergent composition of the invention comprises a surfactant system providing having any combination of a ratio CAC:CMC of less than 0.95; a negative overall charge of the micelles and emulsion-particles, a nonionic surfactant constituting less than 50% w/w of the total surfactant and/or the critical micellar concentration of the surfactant system is above 0.1 Mm in a washing liquor at Standard European conditions; Standard North American conditions or Standard Asia-Pacific conditions. Also the invention provides use of a surfactant system having any combination of said features for improving the enzyme detergency.

Still further from the findings above the invention provides a method for optimizing or screening the enzyme detergency in a detergent composition comprising 0.00001% to 80% of enzyme protein by weight said method comprising
(1) preparing at least two such detergent compositions
(2) measuring one or more of the following parameters in the washing liquor at Standard European conditions and/or Standard North American conditions and/or Standard Asia-Pacific conditions:
   (2a) the CAC
   (2b) the CMC
   (2c) the overall charge of micelles and emulsion-particles
   (2d) the amount of nonionic surfactant
(3) selecting a detergent composition wherein:
   (3a) CAC:CMC is less than 0.95 or
   (3b) CMC is greater than 0.1 mM or
   (3c) the overall charge of micelles and emulsion-particles is negative or
   (3d) the amount of nonionic surfactant is less than 50% or
   (3e) a combination of one or more of 3a to 3d

A further aspect of the invention relates to the application of lipolytic enzymes in detergent compositions and the importance to optimize the dissociation rate constants in the wash system in order to reduce any generation of odor from short-chain lipid reaction products after the wash process. A problem arises in that on one hand detergent are desirable featuring high association rate constant of lipolytic enzymes to lipid soiling on textiles to gain a high rate of enzymatic removal of lipid material from the textile; on the other hand detergents are desirable featuring a high dissociation rate constant of lipolytic enzymes from lipid soiling on textiles to prevent the lipolytic enzymes generating odor from short-chain lipid reaction products after the wash process. This aspect is particularly relevant when employing high levels of enzymes in the detergent. As described above observing that longer-chain surfactants having lower CMC will in higher concentrations create micelles, which may act as a competing surface for lipolytic enzymes. I particular long-chain non-ionic surfactants have been found to significantly inhibit the performance of a lipolytic enzyme on lipid soiling on textiles.

In this context it has surprisingly been found that the problem may be solved independently from optimizing dissociation and/or association rate constants for the washing process if only surfactants, particularly nonionic surfactants, are added late in the washing process in amount sufficient to create micelles thus creating a competing substrate to any remaining lipid soiling.

Addition of further surfactant late in the washing process may for example be provided either by formulation at least part of the surfactant as a slow or delayed release formulation. In a slow release formulation the surfactant is released slowly over time, so that at some point in the washing process the surfactant concentration exceeds the CMC and micelles starts forming. In a delayed release formulation the surfactant is release quickly only after a certain period of time where after micelles are quickly formed.

Alternatively, the addition of further surfactant late in the washing process may be provided either by adding surfactant, e.g. in conjunction with fabric softener, to the rinsing water in one of the rinsing steps in sufficient amounts to create micelles during rinsing.

Alternatively, instead of adding surfactant late in the process the lipolytic enzyme may be added early in the process for example in a pre-wash step.

In both cases the lipolytic enzyme will after hydrolyzing lipid soiling on the textile bind to the micelles and will be removed along with the washing liquor or the rinsing water, thus reducing any odor generation later in the process.

In context of these aspects the invention provides a composition comprising one or more surfactant components comprised in a slow-release or a delayed release formulation and in amounts wherein the surfactant components, when released into a washing liquor at Standard European conditions and/or Standard North American conditions and/or Standard Asia-Pacific conditions is capable of forming micelles forming a binding site for a lipolytic enzyme.

In one particular embodiment this composition is a fabric softener composition, while in another embodiment the composition is a detergent composition further comprising a lipolytic enzyme, in particular a detergent composition as described above. In particular at least one of the surfactant components is a nonionic surfactant, and more particularly all the surfactant components are nonionic surfactants.

For granular and powder detergents, the slow-release composition may be granular particles, e.g. coated granules. For liquid detergents, the non-ionic surfactant may be incorporated as a dispersion of coated particles.

The particles may be granules or microcapsules, e.g. made by absorbing the nonionic surfactant into a porous or meso-porous carrier. The carrier may be a hydrophobic material such as silica, optionally silylated, a polysaccharide such as starch, cellulose or chitosan, optionally esterified. The coating may comprise substances such as cellulose, cellulose derivatives, polyvinyl alcohol (PVA), polyvinyl pyrrollidone (PVP), tallow, hydrogenated tallow (optionally hydrogenated or hydrolyzed), fatty acids, fatty alcohols, mono-, di- and triglycerides of long-chain fatty acids, ethoxylated fatty alcohols, latexes, hydrocarbons of melting point 50-80° C., and waxes. The coating may also comprise substances such as clays (e.g. kaolin), titanium dioxide, pigments, salts (such as calcium carbonate), and silicone oils.

The slow-release composition may be formulated in analogy with WO 98/06810, EP 583512, WO 01/020985, EP 1101527 or WO 01/083398. It may be formulated so as to be effective for delaying or slowing down release of the surfactant(s) so that the micelles forming a binding site for a lipolytic enzyme is formed only in the last part of the washing process, particularly the last half of the washing process, particularly the last third of the washing process, particularly the last quarter of the washing process, particularly the last fifth of the washing process, particularly the last sixth of the washing process, particularly the last tenth of the washing process.

The invention also provides a method of treating soiled textile, comprising:

a) treating the textile with an aqueous solution comprising a detergent and a lipolytic enzyme, followed by

b) treating the textile with an aqueous solution comprising one or more surfactant components in amounts wherein the surfactant components at ambient temperature is capable of forming micelles forming a binding site for a lipolytic enzyme.

In particular at least one of the surfactant components is a nonionic surfactant, and more particularly all the surfactant components are nonionic surfactants.

Builders

The detergent composition may comprise builders. In the detergent compositions where enzymes have been added to replace the builder component(s) the amount of builder is reduced compared to conventional detergent compositions.

Detergency builder salts are normally included in amounts of from 5% to 80% by weight of the composition.

In a particular embodiment of the present invention the powder detergent composition comprises 0 to 50% or 5 to 50% of builder after replacement with enzyme. In a more particular embodiment of the present invention the powder detergent compositions comprise 10 to 35% of builder after replacement with enzyme. In an even more particular embodiment of the present invention the powder detergent composition comprises 15 to 25% of builder after replacement with enzyme.

In a particular embodiment of the present invention the liquid detergent composition comprises 0 to 10% of builder after replacement with enzyme, in a more particular embodiment of the present invention the liquid detergent composition comprises 0 to 5% of builder before replacement with enzyme, in a most particular embodiment of the present invention the liquid detergent composition comprise less than 2% of builder after replacement with enzyme.

In a particular embodiment of the present invention the detergent composition comprises more than 1% of builder. In a particular embodiment of the present invention the detergent composition comprises more than 2% of builder. In a particular embodiment of the present invention the detergent composition comprises less than 35% of builder. In a more particular embodiment of the present invention the detergent composition comprises less than 25% of builder.

In a particular embodiment of the present invention the detergent composition comprises 0 to 50% of builder after replacement with enzymes. In a more particular embodiment of the present invention the detergent composition comprises 0 to 35% of builder after replacement with enzymes.

In another particular embodiment of the present invention the detergent composition comprises 0 to 50% of enzyme replaceable builders and enzymes.

In a more particular embodiment of the present invention the detergent composition comprises 10 to 35% of enzyme replaceable builders and enzymes.

In another particular embodiment of the present invention the detergent composition comprises 0 to 15% of enzyme replaceable builders and enzymes.

In a more particular embodiment of the present invention the detergent composition comprises 2 to 8% of enzyme replaceable builders and enzymes.

Following builders may be present in detergent compositions and/or be a target of replacement:

Conventional builder system include aluminosilicate materials, silicates, polycarboxylates and fatty acids, materials such as ethylenediamine tetraacetate, metal ion sequestrants such as aminopolyphosphonates, particularly ethylenediamine tetramethylene phosphonic acid and diethylene triamine pentamethylenephosphonic acid. Other builders include phosphate builder; diphosphate, triphosphate, phosphonate, especially sodium tripolyphosphate are also used, this may be used in combination with orthophosphate, and/or sodium pyrophosphate.

Used complexing agents are carbonate, nitrilotriacetic acid, ethylenediaminetetraacetic acid, diethylenetriaminepentaacetic acid and alkyl- or alkenylsuccinic acid.

Other builders can be an inorganic ion exchange material, commonly an inorganic hydrated aluminosilicate material, more particularly a hydrated synthetic zeolite such as hydrated zeolite A(zeolite 4A), X, B, HS or MAP (maximum aluminium zeolite P), commercially available as Duocil A24™ from Ineos Ltd, UK.

Another inorganic builder material found in detergent compositions is layered silicate, e.g. SKS-6 (Hoechst). SKS-6 is a crystalline layered silicate consisting of sodium silicate (Na₂Si₂O₅).

Especially used builder systems for use in detergent compositions include a mixture of a water-insoluble aluminosilicate builder such as zeolite A or of a layered silicate (SKS-6), and a water-soluble carboxylate chelating agent such as citric acid.

A suitable chelant for inclusion in the detergent compositons in accordance with the invention is ethylenediamine-N,N′-disuccinic acid (EDDS) or the alkali metal, alkaline earth metal, ammonium, or substituted ammonium salts thereof, or mixtures thereof. Preferred EDDS compounds are the free acid form and the sodium or magnesium salt thereof. Examples of such preferred sodium salts of EDDS include Na₂EDDS and Na₄EDDS. Examples of such preferred magnesium salts of EDDS include MgEDDS and Mg₂EDDS. The magnesium salts are the most preferred for inclusion in compositions in accordance with the invention.

Other builder materials that can form part of the builder system for use in granular compositions include inorganic materials such as alkali metal carbonates, bicarbonates, silicates, and organic materials such as the organic phosphonates, amino polyalkylene phosphonates and amino polycarboxylates.

The builder may be selected from the group consisting of polyphosphate, zeolite, sodium carbonate, sodium citrate, layered silicate, amorphous aluminosilicates and combinations thereof.

In a particular embodiment of the present invention the builder which has been partly replaced by enzymes are selected from the group consisting of zeolite builders e.g. zeolite A and P, and phosphate builders e.g. sodiumtripolyphosphate.

In a particular embodiment of the present invention the enzyme replaceable builders are selected from the group consisting of Zeolite, phosphate builders and fatty acid.

In a particular embodiment of the present invention the replaceable builders are selected from monomeric polycarboxylates such as citrates, gluconates, oxydisuccinates, glycerol mono-, di- or trisuccinates, carboxymethyloxysuccinates, carboxymethyloxymalonates, dipicolinates, hydroxyethyliminodiacetates, alkyl- and alkenylmalonates, alkyl- and alkenylsuccinates; and sulfonated polycarboxylates or sulfonated fatty acids salt.

Carboxylate which are found in detergent compositions include carboxylates containing one carboxy group such as actic acid, glycolic acid and ether derivatives thereof as disclosed in Belgian Patent Nos. 831,368, 821,369 and 821,370. Polycarboxylates containing two carboxy groups include the water-soluble salts of succinic acid, malonic acid, (ethylenedioxy) diacetic acid, maleic acid, diglycollic acid, tartaric acid, tartronic acid and fumaric acid, as well as the ether carboxylates described in DE 2,446,686, and 2,446,487, U.S. Pat. No. 3,935,257 and the sulfinyl carboxylates described in Belgian Patent No. 840,623. Polycarboxylates containing three carboxy groups include, in particular, water-soluble citrates, aconitrates and citraconates as well as succinate derivatives such as the carboxymethyloxysuccinates described in British Patent No. 1,379,241, lactoxysuccinates described in Netherlands Application 7205873, and the oxypolycarboxylate materials such as 2-oxa-1,1,3-propane tricarboxylates described in British Patent No. 1,387,447.

Polycarboxylates containing four carboxy groups include oxydisuccinates disclosed in British Patent No. 1,261,829, 1,1,2,2,-ethane tetracarboxylates, 1,1,3,3-propane tetracarboxylates containing sulfo substituents include the sulfosuccinate derivatives disclosed in British Patent Nos. 1,398,421 and 1,398,422 and in U.S. Pat. No. 3,936,448, and the sulfonated pyrolysed citrates described in British Patent No. 1,082,179, while polycarboxylates containing phosphone substituents are disclosed in British Patent No. 1,439,000.

Alicyclic and heterocyclic polycarboxylates include cis, cis, ciscyclopentanetetracarboxylates; cyclopentadienide pentacarboxylates; cis, cis, cis-2,3,4,5-tetrahydrofuran tetracarboxylates; ds-2,5-tetrahydrofuran dicarboxylates; 2,2,5,5-tetrahydrofuran tetracarboxylates; 1,2,3,4,5,6-hexanehexacarboxylates and carboxymethyl derivatives of polyhydric alcohols such as sorbitol, mannitol and xylitol. Aromatic polycarboxylates include mellitic acid, pyromellitic acid and the phthalic acid derivatives disclosed in British Patent No. 1,425,343.

Of the above, the preferred polycarboxylates are hydroxy-carboxylates containing up to three carboxy groups per molecule, more particularly citrates.

Bleaches

As well as the surfactants, builders and polymers mentioned vide supra, the detergent composition may also contain bleaching components which can be replaced or partly replaced by enzymes. When included in the detergent, bleaches typically comprise from between 2% to 30% by weight. After replacement with enzymes the detergent compositions comprise 0 to 15% by weight of bleaches, in a particular embodiment of the present invention the detergent composition comprise 0 to 8% of bleaches after replacement with enzymes.

In a more particular embodiment of the present invention the detergent composition comprises 3 to 8% of enzyme replaceable bleaches which has been partly or fully replaced with enzymes. The detergent may contain a bleaching system, which may comprise a H₂O₂ source such as perborate, PB1, PB4 or percarbonate with a particle size of 400-800 microns, these bleaching agent components can include one or more oxygen bleaching agents and, depending upon the bleaching agent chosen, one or more bleach activators. When present, oxygen bleaching compounds will typically be present at levels of from about 1% to about 25%. In general, bleaching compounds are optional added components in non-liquid formulations, e.g. granular detergents.

The bleaching agent component for use herein can be any of the bleaching agents useful for detergent compositions including oxygen bleaches as well as others known in the art.

The bleaching agent suitable for the present invention can be an activated or non-activated bleaching agent.

One category of oxygen bleaching agent that can be used encompasses percarboxylic acid bleaching agents and salts thereof. Suitable examples of this class of agents include magnesium monoperoxyphthalate hexahydrate, the magnesium salt of meta-chloro perbenzoic acid, 4-nonylamino-4-oxoperoxybutyric acid and diperoxydodecanedioic acid. Such bleaching agents are disclosed in U.S. Pat. No. 4,483,781, U.S. Pat. No. 740,446, EP 0 133 354 and U.S. Pat. No. 4,412,934. Highly preferred bleaching agents also include 6-nonylamino-6-oxoperoxycaproic acid as described in U.S. Pat. No. 4,634,551. The free peracid bleach 6-(phthalimido) peroxyhexanoic acid (or PAP) from Ausimont or Solvay also preferred.

Another category of bleaching agents that can be used encompasses the halogen bleaching agents. Examples of hypohalite generating bleaching agents, for example, include trichloro isocyanuric acid and the sodium and potassium dichloroisocyanurates and N-chloro and N-bromo alkane sulfonamides. Such materials are normally added at 0.5-10% by weight of the finished product, preferably 1-5% by weight.

The hydrogen peroxide releasing agents can be used in combination with bleach activators such as tetra-acetylethylenediamine (TAED), nonanoyloxybenzenesulfonate (NOBS, described in U.S. Pat. No. 4,412,934), 3,5,5-trimethylhexsanoyloxybenzenesulfonate (ISONOBS, described in EP 120 591) or pentaacetylglucose (PAG), which are perhydrolyzed to form a peracid as the active bleaching species, leading to improved bleaching effect. In addition, very suitable are the bleach activators C8(6-octanamido-caproyl) oxybenzene-sulfonate, C9(6-nonanamido caproyl) oxybenzenesulfonate and C10 (6-decanamido caproyl) oxybenzenesulfonate or mixtures thereof. Also suitable activators are acylated citrate esters such as disclosed in European Patent Application No. 91870207.7.

Useful bleaching agents, including peroxyacids and bleaching systems comprising bleach activators and peroxygen bleaching compounds for use in cleaning compositions according to the invention are described in application U.S. Ser. No. 08/136,626. The bleaching system may comprise peroxyacids of e.g. the amide, imide, or sulfone type.

The hydrogen peroxide may also be present by adding an enzymatic system (i.e. an enzyme and a substrate therefore) which is capable of generation of hydrogen peroxide at the beginning or during the washing and/or rinsing process. Such enzymatic systems are disclosed in European Patent Application EP 0 537 381.

Bleaching agents other than oxygen bleaching agents are also known in the art and can be utilized herein. One type of non-oxygen bleaching agent of particular interest includes photoactivated bleaching agents such as the sulfonated zinc and/or aluminium phthalocyanines. These materials can be deposited upon the substrate during the washing process. Upon irradiation with light, in the presence of oxygen, such as by hanging clothes out to dry in the daylight, the sulfonated zinc phthalocyanine is activated and, consequently, the substrate is bleached. Preferred zinc phthalocyanine and a photoactivated bleaching process are described in U.S. Pat. No. 4,033,718. Typically, detergent composition will contain about 0.025% to about 1.25%, by weight, of sulfonated zinc phthalocyanine.

Bleaching agents may also comprise a manganese catalyst. The manganese catalyst may, e.g., be one of the compounds described in “Efficient manganese catalysts for low-temperature bleaching”, Nature 369, 1994, pp. 637-639.

In a particular embodiment of the present invention the enzyme replaceable bleaches are selected from the group consisting of percarbonate, perborate and bleach activators such as TAED and NOBS.

Additional Detergent Components

Other optional ingredients include suds suppressors, softening agents, polymeric dye-transfer inhibiting agents, encapsulating materials, antiredeposition and soil suspension agents, optical brighteners and soil release agents

Suds Suppressors

An optional ingredient is a suds suppressor, exemplified by silicones, and silica-silicone mixtures. Silicones can generally be represented by alkylated polysiloxane materials, while silica is normally used in finely divided forms exemplified by silica aerogels and xerogels and hydrophobic silicas of various types. Theses materials can be incorporated as particulates, in which the suds suppressor is advantageously releasable incorporated in a water-soluble or waterdispersible, substantially non surface-active detergent impermeable carrier. Alternatively the suds suppressor can be dissolved or dispersed in a liquid carrier and applied by spraying on to one or more of the other components.

Preferred silicone suds controlling agents are disclosed in U.S. Pat. No. 3,933,672. Other particularly useful suds suppressors are the self-emulsifying silicone suds suppressors, described in German Patent Application DTOS 2,646,126. An example of such a compound is DC-544, commercially available form Dow Corning, which is a siloxane-glycol copolymer. Especially preferred suds controlling agent are the suds suppressor system comprising a mixture of silicone oils and 2-alkyl-alkanols. Suitable 2-alkyl-alkanols are 2-butyl-octanol which are commercially available under the trade name Isofol 12 R.

Such suds suppressor system are described in European Patent Application EP 0 593 841.

Especially preferred silicone suds controlling agents are described in European Patent Application No. 92201649.8. Said compositions can comprise a silicone/silica mixture in combination with fumed nonporous silica such as Aerosil^{R}.

The suds suppressors described above are normally employed at levels of from 0.001% to 2% by weight of the composition, preferably from 0.01% to 1% by weight.

Softening Agents

Fabric softening agents can also be incorporated into laundry detergent compositions in accordance with the present invention. These agents may be inorganic or organic in type. Inorganic softening agents are exemplified by the smectite clays disclosed in GB-A-1 400898 and in U.S. Pat. No. 5,019,292. Organic fabric softening agents include the water insoluble tertiary amines as disclosed in GB-A1 514 276 and EP 0 011 340 and their combination with mono C₁₂-C₁₄ quaternary ammonium salts are disclosed in EP-B-0 026 528 and di-long-chain amides as disclosed in EP 0 242 919. Other useful organic ingredients of fabric softening systems include high molecular weight polyethylene oxide materials as disclosed in EP 0 299 575 and 0 313 146.

Levels of smectite clay are normally in the range from 5% to 15%, more preferably from 8% to 12% by weight, with the material being added as a dry mixed component to the remainder of the formulation. Organic fabric softening agents such as the water-insoluble tertiary amines or dilong chain amide materials are incorporated at levels of from 0.5% to 5% by weight, normally from 1% to 3% by weight whilst the high molecular weight polyethylene oxide materials and the water soluble cationic materials are added at levels of from 0.1% to 2%, normally from 0.15% to 1.5% by weight. These materials are normally added to the spray dried portion of the composition, although in some instances it may be more convenient to add them as a dry mixed particulate, or spray them as molten liquid on to other solid components of the composition.

Soil Suspending or Dispersing Polymers

In some detergent compositions soil suspending or dispersing polymers are used. Soil suspending polymers are normally included in the detergent composition in the amount of 0 to 10%, but after replacement of soil suspending polymers with enzymes the amount of soil suspending polymers are reduced to 0 to 6%, more particular the amounts of soil suspending polymers present in the detergent composition are reduced to 0 to 4%.

In a particular embodiment of the present invention the detergent composition comprises less than 6% of soil suspending polymer after replacement with enzymes, in a more particular embodiment of the present invention the detergent composition comprises less than 4% of soil suspending polymer after replacement with enzymes. In a particular embodiment of the present invention the detergent composition comprises more than 0.01% of soil suspending polymer after replacement with enzymes. In a particular embodiment of the present invention the detergent composition comprises more than 1% of soil suspending polymer after replacement with enzymes.

In a particular embodiment of the present invention the detergent composition comprises 0 to 6% of enzyme replaceable soil suspending polymer and enzymes. In a more particular embodiment of the present invention the detergent composition comprises 2 to 4% of enzyme replaceable soil suspending polymer and enzymes.

Soil suspending polymers that may be present in detergent compositions include polycarboxylate polymers such as polyacrylates, acrylic/maleic copolymers and lauryl methacrylate/acrylic acid copolymers and polyaspartates.

Other soil suspending polymers which are suitable in detergent compositions are carboxymethylcellulose, poly(vinylpyrrolidone), poly(ethylene glycol), poly(vinyl alcohol), poly(vinylpyridine-N-oxide), poly(vinylimidazole). The composition may also contain soil release polymers, such as sulfonated and unsulfonated PET/POET polymers, both end capped and non end capped, and polyethylene glycol/polyvinyl alcohol graft copolymers such as Sokolan HP22™, Sokolan CP-5™ and CMC™.

Other suitable soil suspending polymers are water-soluble organic salts are the homo- or co-polymeric acids or their salts, in which the polycarboxylic acid comprises at least two carboxyl radicals separated form each other by not more than two carbon atoms.

Polymers of this type are disclosed in GB-A-1,596,756. Examples of such salts are polyacrylates of MW 2000-5000 and their copolymers with maleic anhydride, such copolymers having a molecular weight of from 20,000 to 70,000, especially about 40,000. Polymers are in particular present in alkali metal salt especially sodium salt, form.

Polymeric Dye-Transfer Inhibiting Agents

Besides from the polymers mentioned above, the detergent compositions according to the present invention may also comprise from 0.001% to 10%, preferably from 0.01% to 2%, more preferably form 0.05% to 1% by weight of polymeric dye-transfer inhibiting agents. Said polymeric dye-transfer inhibiting agents are normally incorporated into detergent compositions in order to inhibit the transfer of dyes from colored fabrics onto fabrics washed therewith. These polymers have the ability of complexing or adsorbing the fugitive dyes washed out of dyed fabrics before the dyes have the opportunity to become attached to other articles in the wash.

Especially suitable polymeric dye-transfer inhibiting agents are polyamine N-oxide polymers, copolymers of N-vinyl-pyrrolidone and N-vinylimidazole, polyvinylpyrrolidone polymers, polyvinyloxazolidones and polyvinylimidazoles or mixtures thereof.

Encapsulating Materials

Encapsulating materials are used to encapsulate detergent components which may be sensitive to or aggressive towards other detergent components.

Especially suitable encapsulating materials are water soluble capsules which consist of a matrix of polysaccharide and polyhydroxy compounds such as described in GB 1,464,616.

Other suitable water soluble encapsulating materials comprise dextrins derived from ungelatinized starch acid esters of substituted dicarboxylic acids such as described in U.S. Pat. No. 3,455,838. These acid-ester dextrins are, preferably, prepared from such starches as waxy maize, waxy sorghum, sago, tapioca and potato. Suitable examples of said encapsulation materials include N-Lok manufactured by National Starch. The N-Lok encapsulating material consists of a modified maize starch and glucose. The starch is modified by adding monofunctional substituted groups such as octenyl succinic acid anhydride.

Optical Brighteners

Preferred optical brighteners are anionic in character, examples of which are disodium 4,4′-bis(2-diethanolamino-4-anilino-s triazin-6-ylamino)stilbene-2:2′ disulfonate, disodium 4,-4′-bis-(2-morpholino-4-anilino-s-triazin-6-ylamino-stilbene-2:2′-disulfonate, disodium 4,4′-bis-(2,4-dianilino-s-triazin-6-ylamino)stilbene-2:2′-disulfonate, monosodium 4′,4″-bis-(2,4-dianilino-s-tri-azin-6 ylamino)stilbene-2-sulfonate, disodium 4,4′-bis-(2-anilino-4-(N-methyl-N-2-hydroxyethylamino)-s-triazin-6-ylamino)stilbene-2,2′-disulfonate, di-sodium 4,4′-bis-(4-phenyl-2,1,3-triazol-2-yl)-stilbene-2,2′ disulfonate, di-so-dium 4,4′bis(2-anilino-4-(1-methyl-2-hydroxyethylamino)-s-triazin-6-ylami-no)stilbene-2,2′disulfonate, sodium 2(stilbyl-4″-(naphtho-1′,2′:4,5)-1,2,3,-triazole-2″-sulfonate and 4,4′-bis(2-sulfostyryl)biphenyl.

Other Polymers

Other useful polymeric materials are the polyethylene glycols, particularly those of molecular weight 1000-10000, more particularly 2000 to 8000 and most preferably about 4000. These are used at levels of from 0.20% to 5% more preferably from 0.25% to 2.5% by weight. These polymers and the previously mentioned homo- or co-polymeric poly-carboxylate salts are valuable for improving whiteness maintenance, fabric ash deposition, and cleaning performance on clay, proteinaceous and oxidizable soils in the presence of transition metal impurities.

Soil Release Agents

Soil release agents useful in compositions of the present invention are conventionally copolymers or terpolymers of terephthalic acid with ethylene glycol and/or propylene glycol units in various arrangements. Examples of such polymers are disclosed in U.S. Pat. Nos. 4,116,885 and 4,711,730 and EP 0 272 033. A particular preferred polymer in accordance with EP 0 272 033 has the formula:
(CH₃(PEG)₄₃)_{0.75}(POH)_{0.25}[T-PO)_{2.8}(T-PEG)_{0.4}]T(POH)_{0.25}((PEG)₄₃CH₃)_{0.75}
where PEG is —(OC₂H₄)O—, PO is (OC₃H₆O) and T is (pOOC₆H₄CO).

Also very useful are modified polyesters as random copolymers of dimethyl terephthalate, dimethyl sulfoisophthalate, ethylene glycol and 1,2-propanediol, the end groups consisting primarily of sulfobenzoate and secondarily of mono esters of ethylene glycol and/or 1,2-propanediol. The target is to obtain a polymer capped at both end by sulfobenzoate groups, “primarily”, in the present context most of said copolymers herein will be endcapped by sulfobenzoate groups. However, some copolymers will be less than fully capped, and therefore their end groups may consist of monoester of ethylene glycol and/or 1,2-propanediol, thereof consist “secondarily” of such species.

The selected polyesters herein contain about 46% by weight of dimethyl terephthalic acid, about 16% by weight of 1,2-propanediol, about 10% by weight ethylene glycol, about 13% by weight of dimethyl sulfobenzoic acid and about 15% by weight of sulfoisophthalic acid, and have a molecular weight of about 3.000. The polyesters and their method of preparation are described in detail in EP 311 342. These other conventional detergent ingredients may include, but are not limited to, any one or more of the following; clays, anticorrosion agents, bactericides, tarnish inhibitors, soap, sequestrants, cellulose ethers and esters, sodium sulphate, sodium silicate, sodium chloride, calcium chloride, sodium bicarbonate, other inorganic salts, fluorescers, anti foam agents, foam boosters, hydrotropes, UV protection agents, anti-wrinkling agents, coloured speckles, and perfume.

The compositions of the invention may be of any suitable physical form such as particulates (powders, granules, tablets), liquids, pastes gels or bars. In a particular embodiment of the present invention the detergent composition is in particulate form. In another particular embodiment of the present invention the detergent composition is in liquid form.

Powders of low to moderate bulk density may be prepared by spray drying a slurry, and optionally post dosing (dry mixing) further ingredients. Concentrated or compact powders may be prepared by mixing and granulating processes, e.g. using a high speed mixer/granulator, or other non-tower processes.

Tablets may be prepared by compacting powders, especially concentrated powders. Liquid detergent compositions may be prepared by mixing the essential and optional ingredients in any desired order to provide compositions containing the ingredients in the requisite concentrations.

Single-dose ‘liquid tablets’ can be prepared by taking a concentrated liquid detergent containing very little water and placing the amount required for 1 wash inside of a water-soluble polymer pouch.

### EXAMPLES

### Example 1

A standard European laundry powder detergent was prepared. It contained 15% of surfactant of which 6% was LAS, 3% was AES and 6% was nonionic surfactants. It further contained 47% builder comprising fatty acid, zeolite A, carbonate and silicate).

A launder meter wash was performed under standard European washing conditions with the following stains: grass stain on cotton (EMPA 164), mineral oil/black ink on cotton (EMPA 106), milk cacao on cotton (EMPA 112), pigment/sebum on cotton (Wfk 10D), vegetable oil/milk/ink on cotton (Wfk 10ppm), pre-aged egg yolk on cotton (Wfk 10eg), used motor oil on cotton/polyester (Wfk 20gm), and direct blue dye on cotton (Wfk DB71). The total detergent concentration was 5 g/litre.

The tests showed that by reducing the level of surfactant in the detergent composition to 25% of normal level, and replacing it with 0.01% protease enzyme protein derived from Bacillus clausii, it was possible to get a similar or better wash result than the detergent composition with normal level of surfactants.

Wash Result (higher is better)

| Composition | EMPA 164 | EMPA 112 | Wfk 10 ppm |
|---|---|---|---|
| Normal surfactant level and | 42 | 39 | 62 |
| no enzyme | | | |
| With reduced level of | 35 | 33 | 56 |
| surfactant (3.75%) | | | |
| and no enzyme | | | |
| With reduced level of | 43 | 43 | 65 |
| surfactant (3.75%) | | | |
| and enzyme | | | |

The remission values of the textiles were measured at 460 nm with a UV filter using a MacBeth color eye system.

### Example 2

A standard North American laundry liquid detergent was prepared. It contained 23% of surfactant of which 16% was AES, 5% was LAS and 2% was nonionic surfactants. It further contained 6% builder comprising soap, citric acid, DTPA and calcium formate.

A full scale wash was conducted under Standard North American conditions with the following stains: mineral oil/ink on cotton (EMPA 106), milk cacao on cotton (EMPA 112), grass on cotton (EMPA 164), pigment/sebum on cotton (Wfk 10D), vegetable oil/milk/ink on cotton (Wfk 10ppm), egg yolk on cotton (Wfk 10eg), used motoroil on cotton/polyester (Wfk 20gm), redwine on cotton (Wfk 20L), tomato ketchup on cotton/polyester (Wfk 20T), direct blue dye on cotton (Wfk DB71), colored olive oil on cotton (CS-4), butterfat on cotton (CS-10), lipstick on cotton/polyester (Wfk 20LS), makeup on cotton/polyester (Wfk 20MU), 15 different soils on cotton (EMPA 102), rice starch on cotton (CS-28), chocolate pudding on cotton (EMPA 170), shoe polish on cotton/polyester (Wfk 20S), coca cola on cotton/polyester (Wfk 20H), motor oil on cotton/polyester (Wfk 20M), soot on cotton/polyester (Wfk 20RM), clay on cotton/polyester (Wfk 20TE), soya on cotton/polyester (Wfk 20V), homemade lard/sudan red and sesame oil on white cotton/lycra, olive oil, beef dripping, chicken fat, lard, and corn oil stains on green cotton/lycra. The total detergent concentration was 1.5 g/litre.

The tests showed that by reducing the level of surfactant in the detergent composition to 50% of normal level, and replacing it with 0.1% Lipase protein derived from Thermomyces lanuginosus, it was possible to get an equal or better wash result than with the detergent composition with normal level of surfactant.

Wash Result (higher is better)

| | | | Lard/ | | | | | |
|---|---|---|---|---|---|---|---|---|
| | | | Sudan | Sesame | Corn | Olive | Beef | Chicken |
| Composition | Wfk20LS | CS10 | Red | Oil | Oil | Oil | Dripping | Fat |
| Normal surfactant | 45 | 51 | 36 | 70 | 1.9 | 2.1 | 2.1 | 2.1 |
| level and | | | | | | | | |
| no enzyme | | | | | | | | |
| Reduced level | 41 | 46 | 33 | 66 | 1.7 | 1.5 | 1.3 | 1.8 |
| of surfactants | | | | | | | | |
| (11.5%) and no | | | | | | | | |
| enzyme | | | | | | | | |
| Reduced level | 53 | 51 | 37 | 71 | 4 | 4.0 | 3.5 | 4.1 |
| of surfactants | | | | | | | | |
| (11.5%) and | | | | | | | | |
| enzyme | | | | | | | | |

The remission values of the textiles were measured at 460 nm with a UV filter using a MacBeth color eye system.

### Example 3

A standard European laundry powder detergent was prepared. It comprised 0.004% protease protein from Bacillus clausii, 15% of surfactant of which 3% was AES, 6% was LAS and 6% was nonionic surfactants. It further comprised 47% builder comprising fatty acid, zeolite A, carbonate, silicate, and it comprised 5% polycarboxylate polymers.

A launder-o-meter wash under Standard European conditions was performed on cotton with carbon black/mineral oil stain (EMPA 101). The total detergent concentration was 5 g/litre.

The tests showed that by reducing the level of surfactants and the level of polymers in the detergent composition, and replacing them with 20 ECU of endo-cellulase from Bacillus subtilis/g detergent, it was possible to get an equivalent or better wash result than with the detergent composition with normal levels of surfactants and polymers.

Wash Result (higher is better)

| Composition | EMPA 101 |
|---|---|
| Normal level of surfactants & dispersing | 28 |
| polymers and no enzyme | |
| Reduced level of surfactants (9.8%) and dispersing | 25 |
| polymers (3.2%) and no enzyme | |
| Reduced level of surfactants (9.8%) & dispersing | 32 |
| polymers (3.2%) and enzyme | |

The remission values of the textiles were measured at 460 nm with a UV filter using a MacBeth color eye system.

### Example 4

A standard European laundry powder detergent was prepared. It contained 15% of surfactant of which 3% was AES, 6% was LAS and 6% was nonionic surfactants. It further contained 47% builder comprising fatty acid, zeolite A, carbonate, silicate, and it comprised 5% polycarboxylate polymers.

A full-scale wash was performed under standard European washing conditions with the following stains: grass stain on cotton (EMPA 164), mineral oil/black ink on cotton (EMPA 106), milk cacao on cotton (EMPA 112), pigment/sebum on cotton (Wfk 10D), vegetable oil/milk/ink on cotton (Wfk 10ppm), pre-aged egg yolk on cotton (Wfk 10eg), used motor oil on cotton/polyester (Wfk 20gm), red wine on cotton/polyester (Wfk 20L), tomato ketchup on cotton/polyester (Wfk 20T), and direct blue dye on cotton (Wfk DB71). Soiled ballast fabric (Wfk SBL) was also added to the wash. The total detergent concentration was 5 g/litre. The tests showed that by reducing the level of surfactant in the detergent composition to 10% of normal level, and replacing it with 0.02% protease protein derived from Bacillus clausii, 0.02% lipase protein derived from Thermomyces lanuginosus, 0.01% amylase protein derived from Bacillus subtilis, 0.0025% endo-cellulase protein derived from Humicola insolens, and 0.0025% cellulase protein derived from Thielavia terrestris, it was possible to get an equal or better wash result than with the detergent composition with normal level of surfactants.

Wash Result (higher is better)

| Composition | EMPA 164 | EMPA 112 | Wfk 10 ppm |
|---|---|---|---|
| Normal surfactant level and | 35 | 29 | 49 |
| no enzyme | | | |
| Reduced level of surfactants | 33 | 27 | 43 |
| (1.5%) and no enzyme | | | |
| Reduced level of surfactants | 36 | 43 | 55 |
| (1.5%) and enzyme | | | |

The remission values of the textiles were measured at 460 nm with a UV filter using a MacBeth color eye system.

### Example 5

A standard European powder detergent was prepared. It contained 15% of surfactant of which 3% was AES, 6% was LAS and 6% was nonionic surfactants. It further contained 47% builder comprising fatty acid, zeolite A, carbonate, silicate, and it comprised 5% polycarboxylate polymers and 15% perborate, and 4% TAED.

A launder meter wash was performed under standard European washing conditions with the following stains: grass stain on cotton (EMPA 164), mineral oil/black ink on cotton (EMPA 106), milk cacao on cotton (EMPA 112), pigment/sebum on cotton (Wfk 10D), vegetable oil/milk/ink on cotton (Wfk 10ppm), pre-aged egg yolk on cotton (Wfk 10eg), used motor oil on cotton/polyester (Wfk 20gm), red wine on cotton/polyester (Wfk 20L), tomato ketchup on cotton/polyester (Wfk 20T), and direct blue dye on cotton (Wfk DB71). The total detergent concentration was 5 g/litre.

The tests showed that by reducing the level of surfactants in the detergent composition to 25% of normal level, and replacing them with 0.076% protease protein derived from Bacillus halmapalus, 0.006% lipase protein derived from Thermomyces lanuginosus, 0.02% amylase protein derived from Bacillus subtilis, 0.005% endo-cellulase protein derived from Humicola insolens, 0.02% mannanase protein derived from an alkalophilic bacillus, and 0.02% pectate lyase protein derived from Bacillus licheniformis, it was possible to get an equal or better wash result than with the detergent composition with normal level of surfactant.

Wash Result (higher is better)

| Composition | EMPA 164 | Wfk 10D | Wfk 10eg | EMPA 112 |
|---|---|---|---|---|
| Normal surfactant | 31 | 56 | 45 | 31 |
| level and no enzyme | | | | |
| Reduced level of | 29 | 54 | 44 | 27 |
| surfactant (3.75%) | | | | |
| and no enzyme | | | | |
| Reduced level of | 41 | 63 | 56 | 51 |
| surfactant (3.75%) | | | | |
| and enzyme | | | | |

The remission values of the textiles were measured at 460 nm with a UV filter using a MacBeth color eye system.

### Example 6

A standard European laundry powder detergent was prepared. It contained 15% of surfactant of which 6% was LAS, 3% was AES and 6% was nonionic surfactants. It further contained 47% builder consisting of fatty acid, sodium tripolyphosphate (STPP), carbonate & silicate, 5% polycarboxylate dispersing polymers.

A launder-o-meter wash was performed under standard European washing conditions with the following stains: grass stain on cotton (EMPA 164), mineral oil/black ink on cotton (EMPA 106), milk cacao on cotton (EMPA 112), pigment/sebum on cotton (Wfk 10D), vegetable oil/mill/ink on cotton (Wfk 10ppm), pre-aged egg yolk on cotton (Wfk 10eg), used motor oil on cotton/polyester (Wfk 20gm), red wine on cotton/polyester (Wfk 20L), tomato ketchup on cotton/polyester (Wfk 20T), and direct blue dye on cotton (Wfk DB71). The total detergent concentration was 5 g/litre.

The tests showed that by reducing the level of surfactant in the detergent composition to 25% of normal level, and replacing it with 0.076% protease protein derived from Bacillus halmapalus, 0.03% lipase protein derived from Thermomyces lanuginosus, 0.02% amylase protein derived from Bacillus subtilis, 0.006% endo-cellulase protein derived from Humicola insolens, 0.02% mannanase protein derived from an alkalophilic bacillus, and 0.02% of pectate lyase protein derived from Bacillus licheniformis, it was possible to get an equal or better wash result than with the detergent composition with normal level of surfactants.

Wash Result (higher is better)

| | EMPA | EMPA | Wfk | EMPA |
|---|---|---|---|---|
| Composition | 112 | 164 | 10 ppm | 106 |
| Normal level of surfactants | 43 | 33 | 59 | 36 |
| and no enzyme | | | | |
| Reduced level of surfactants | 38 | 29 | 57 | 33 |
| (3.75%) and no enzyme | | | | |
| Reduced level of surfactants | 56 | 37 | 64 | 39 |
| (3.75%) and enzyme | | | | |

The remission values of the textiles were measured at 460 nm with a UV filter using a MacBeth color eye system.

### Example 7

A standard European laundry powder detergent was prepared. It contained 15% of surfactant of which 6% was LAS, 3% was AES and 6% was nonionic surfactants. It further contained 47% builder consisting of fatty acid, zeolite A, carbonate & silicate, 5% polycarboxylate dispersing polymers, 15% sodium perborate, and 4% tetraacetylethylenediamine (TAED).

A launder-o-meter wash was performed under standard European washing conditions with the following stains: grass stain on cotton (EMPA 164), mineral oil/black ink on cotton (EMPA 106), milk cacao on cotton (EMPA 112), pigment/sebum on cotton (Wfk 10D), vegetable oil/milk/ink on cotton (Wfk 10ppm), pre-aged egg yolk on cotton (Wfk 10eg), used motor oil on cotton/polyester (Wfk 20gm), red wine on cotton/polyester (Wfk 20L), tomato ketchup on cotton/polyester (Wfk 20T), and direct blue dye on cotton (Wfk DB71). The total detergent concentration was 5 g/litre.

The tests showed that by reducing the level of surfactant in the detergent composition to 25% of normal level, and replacing it with 0.076% protease protein derived from Bacillus halmapalus, 0.03% lipase protein derived from Thermomyces lanuginosus, 0.02% amylase protein derived from Bacillus subtilis, 0.006% endo-cellulase protein derived from Humicola insolens, 0.02% mannanase protein derived from an alkalophilic bacillus, and 0.02% of pectate lyase protein derived from Bacillus licheniformis, it was possible to get an equal or better wash result than with the detergent composition with normal level of surfactants.

Wash Result (higher is better)

| | EMPA | EMPA | Wfk | Wfk |
|---|---|---|---|---|
| Composition | 112 | 164 | 10 ppm | 20 gm |
| Normal level of surfactants | 37 | 32 | 57 | 33 |
| and no enzyme | | | | |
| Reduced level of surfactants | 30 | 31 | 55 | 31 |
| (3.75%) and no | | | | |
| enzyme | | | | |
| Reduced level of surfactants | 50 | 36 | 66 | 33 |
| (3.75%) and enzyme | | | | |

The remission values of the textiles were measured at 460 nm with a UV filter using a MacBeth color eye system.

### Example 8

A standard European laundry powder detergent was prepared. It contained 15% of surfactant of which 6% was LAS, 3% was AES and 6% was nonionic surfactants. It further contained 47% builder consisting of fatty acid, 22% zeolite A, carbonate and silicate, and 5% polycarboxylate dispersing polymers.

A launder-o-meter wash was performed under standard European washing conditions with the following stains: grass stain on cotton (EMPA 164), mineral oil/black ink on cotton (EMPA 106), milk cacao on cotton (EMPA 112), pigment/sebum on cotton (Wfk 10D), vegetable oil/milk/ink on cotton (Wfk 10ppm), pre-aged egg yolk on cotton (Wfk 10eg), used motor oil on cotton/polyester (Wfk 20gm), red wine on cotton/polyester (Wfk 20L), tomato ketchup on cotton/polyester (Wfk 20T), and direct blue dye on cotton (Wfk DB71). The total detergent concentration was 5 g/litre.

The tests showed that by reducing the levels of surfactant, zeolite builder and polymers in the detergent composition to 80%, 80% and 80% respectively of normal levels in test 1 and by reducing the levels of surfactant, zeolite builder and polymers in the detergent composition to 60%, 60% and 50% respectively of normal levels in test 2, and replacing them with 0.01% protease protein derived from Bacillus clausii, 0.015% lipase protein derived from Thermomyces lanuginosus, 0.01% amylase protein derived from Bacillus subtilis, 0.0025% endocellulase protein derived from Humicola insolens, and 0.0025% cellulase protein derived from Thielavia terrestris, it was possible to obtain an equal or better cleaning result than with the detergent composition with normal level of surfactants.

Wash Result (higher is better)

| Composition | Wfk 10eg | EMPA 112 |
|---|---|---|
| Normal surfactant, builder, and dispersing | 60 | 34 |
| polymer levels and no enzyme | | |
| Reduced surfactant (12%), zeolite | 54 | 31 |
| builder (18%), and dispersing polymer | | |
| (4%) levels and no enzyme | | |
| Reduced surfactant (9%), zeolite | 53 | 30 |
| builder (13%), and dispersing polymer | | |
| (2.5%) levels and no enzyme | | |
| Reduced surfactant (12%), zeolite | 60 | 48 |
| builder (18%), and dispersing polymer | | |
| (4%) levels and enzyme | | |
| Reduced surfactant (9%), zeolite | 59 | 48 |
| builder (13%), and dispersing polymer | | |
| (2.5%) levels and enzyme | | |

The remission values of the textiles were measured at 460 nm with a UV filter using a MacBeth color eye system.

### Example 9

A standard European laundry powder detergent was prepared. It contained 15% of surfactant of which 6% was LAS, 3% was AES and 6% was nonionic surfactants. It further contained 47% builder consisting of fatty acid, 22% zeolite A, carbonate and silicate, and 5% polycarboxylate dispersing polymers.

A launder-o-meter wash was performed under standard European washing conditions with the following stains: grass stain on cotton (EMPA 164), mineral oil/black ink on cotton (EMPA 106), milk cacao on cotton (EMPA 112), pigment/sebum on cotton (Wfk 10D), vegetable oil/milk/ink on cotton (Wfk 10ppm), pre-aged egg yolk on cotton (Wfk 10eg), used motor oil on cotton/polyester (Wfk 20gm), red wine on cotton/polyester (Wfk 20L), tomato ketchup on cotton/polyester (Wfk 20T), and direct blue dye on cotton (Wfk DB71). The total detergent concentration was 5 g/litre.

The tests showed that by reducing the level of builder in the detergent composition to 25% of normal level, and replacing it with 0.01% protease protein derived from Bacillus clausii, 0.015% lipase protein derived from Thermomyces lanuginosus, 0.01% amylase protein derived from Bacillus subtilis, 0.0025% endo-cellulase protein derived from Humicola insolens, and 0.0025% cellulase protein derived from Thielavia terrestris, it was possible to get an equal or better wash result than with the detergent composition with normal level of builder.

Wash Result (higher is better)

| Composition | EMPA 164 | Wfk 20T | EMPA 112 |
|---|---|---|---|
| Normal level of zeolite builder | 30 | 67 | 33 |
| and no enzyme | | | |
| Reduced level of zeolite builder | 29 | 65 | 30 |
| (5.5%) and no enzyme | | | |
| Reduced level of zeolite builder | 41 | 67 | 47 |
| (5.5%) and enzyme | | | |

The remission values of the textiles were measured at 460 nm with a UV filter using a MacBeth color eye system.

### Example 10

A standard European laundry powder detergent was prepared. It contained 15% of surfactant of which 6% was LAS, 3% was AES and 6% was nonionic surfactants. It further contained 47% builder consisting of fatty acid, 22% zeolite A, carbonate and silicate, and 5% polycarboxylate dispersing polymers.

A launder-o-meter wash was performed under standard European washing conditions with the following stains: grass stain on cotton (EMPA 164), mineral oil/black ink on cotton (EMPA 106), milk cacao on cotton (EMPA 112), pigment/sebum on cotton (Wfk 10D), vegetable oil/milk/ink on cotton (Wfk 10ppm), pre-aged egg yolk on cotton (Wfk 10eg), used motor oil on cotton/polyester (Wfk 20gm), red wine on cotton/polyester (Wfk 20L), tomato ketchup on cotton/polyester (Wfk 20T), and direct blue dye on cotton (Wfk DB71). The total detergent concentration was 5 g/litre.

The tests showed that by reducing the level of polymer in the detergent composition to 25% of normal level, and replacing it with 0.01% protease protein derived from Bacillus clausii, 0.015% lipase protein derived from Thermomyces lanuginosus, 0.01% amylase protein derived from Bacillus subtilis, 0.0025% endo-cellulase protein derived from Humicola insolens, and 0.0025% cellulase protein derived from Thielavia terrestris, it was possible to get an equal or better wash result than with the detergent composition with normal level of polymer.

Wash Result (higher is better)

| Composition | Wfk 10D | EMPA 106 |
|---|---|---|
| Normal level of dispersing polymers | 59 | 36 |
| and no enzyme | | |
| Reduced level of dispersing polymers | 55 | 33 |
| (1.25%) and no enzyme | | |
| Reduced level of dispersing polymers | 59 | 37 |
| (1.25%) and enzyme | | |

The remission values of the textiles were measured at 460 nm with a UV filter using a MacBeth color eye system.

### Example 11

A standard European laundry liquid detergent was prepared. It comprised 0.015% protease protein derived from Bacillus clausii, 0.007% lipase protein derived from Thermomyces lanuginosus, 0.007% amylase protein derived from Bacillus licheniformis, 0.0009% cellulase protein derived from Humicola insolens, 27% of surfactant of which 16.9% was AS, 6.7% was nonionic surfactants, and 3.5% was cationic surfactants (DSDMAC). It further contained 18.7% builder consisting of fatty acid, carbonate, citrate, and boric acid. The enzyme cocktail in this composition was replaced with a new enzyme cocktail consisting of 0.02% protease protein derived from Bacillus clausii, 0.01% amylase protein derived from Bacillus subtilis, 0.03% lipase protein derived from Thermomyces lanuginosus, and 0.002% of an endo-cellulase derived from Humicola insolens.

A launder-o-meter wash was performed under standard European washing conditions with the following stains: grass stain on cotton (EMPA 164), mineral oil/black ink on cotton (EMPA 106), milk cacao on cotton (EMPA 112), pigment/sebum on cotton (Wfk 10D), vegetable oil/milk/ink on cotton (Wfk 10ppm), used motor oil on cotton/polyester (Wfk 20gm), red wine on cotton/polyester (Wfk 20L), tomato ketchup on cotton/polyester (Wfk 20T), lipstick on cotton/polyester (Wfk 20LS), rice starch on cotton (CS-28), chocolate pudding on cotton (EMPA 170), butter fat on cotton (CS-10), and clay on cotton (Wfk 10TE). The total detergent concentration was 5 g/litre.

The tests showed that by reducing the level of surfactant in the detergent composition to 25% of normal level, and replacing it with the new enzyme cocktail listed above, it was possible to get the same wash result as with the detergent composition with normal level of surfactant.

Wash Result (higher is better)

| Composition | EMPA 106 | EMPA 112 | Wfk 10 ppm |
|---|---|---|---|
| Normal level of surfactants | 34 | 47 | 64 |
| and original enzyme cocktail | | | |
| Reduced level of surfactants | 31 | 41 | 60 |
| (6.75%) and original enzyme | | | |
| cocktail | | | |
| Reduced level of surfactants | 34 | 47 | 64 |
| (6.75%) and new enzyme | | | |
| cocktail | | | |

The remission values of the textiles were measured at 460 nm with a UV filter using a MacBeth color eye system.

### Example 12

A standard European laundry powder detergent was prepared. It contained 0.015% protease protein derived from Bacillus clausii, 0.007% lipase protein derived from Thermomyces lanuginosus, 0.007% amylase protein derived from Bacillus licheniformis, 0.0009% cellulase protein derived from Humicola insolens, 21% of surfactant of which 8.1% was LAS, 6.5% was AS, 4.0% was nonionic surfactants, and 2.5% was cationic surfactants (DSDMAC). It further contained 64% builder consisting of fatty acid, carbonate, zeolite A, silicates, and citrate, and also contained 2.7% of dispersing polymers. The enzyme cocktail in this composition was replaced with a new enzyme cocktail consisting of 0.02% protease protein derived from Bacillus clausii, 0.01% amylase protein derived from Bacillus subtilis, 0.03% lipase protein derived from Thermomyces lanuginosus, and 0.002% of an endo-cellulase derived from Humicola insolens.

A launder-o-meter wash was performed under standard European washing conditions with the following stains: grass stain on cotton (EMPA 164), mineral oil/black ink on cotton (EMPA 106), milk cacao on cotton (EMPA 112), pigment/sebum on cotton (Wfk 10D), vegetable oil/milk/ink on cotton (Wfk 10ppm), used motor oil on cotton/polyester (Wfk 20gm), red wine on cotton/polyester (Wfk 20L), tomato ketchup on cotton/polyester (Wfk 20T), lipstick on cotton/polyester (Wfk 20LS), rice starch on cotton (CS-28), chocolate pudding on cotton (EMPA 170), butter fat on cotton (CS-10), and clay on cotton (Wfk 10TE). The total detergent concentration was 5 g/litre.

The tests showed that by reducing the level of surfactants in the detergent composition to 80% in test 1 and 50% in test 2 of normal level, and replacing it with the new enzyme cocktail listed above, it was possible to get the same or better wash result than with the detergent composition with normal level of surfactants.

Wash Results (higher is better)

| Composition | Wfk20LS |
|---|---|
| Normal level of surfactants and original enzyme | 57 |
| cocktail | |
| Reduced level of surfactants (16.8%) and | 54 |
| original enzyme cocktail | |
| Reduced level of surfactants (10.5%) and | 49 |
| original enzyme cocktail | |
| Reduced level of surfactants (16.8%) and new | 63 |
| enzyme cocktail | |
| Reduced level of surfactants (10.5%) and new | 56 |
| enzyme cocktail | |

The remission values of the textiles were measured at 460 nm with a UV filter using a MacBeth color eye system.

### Example 13

A standard European laundry powder detergent was prepared. It contained 0.018% protease protein derived from Bacillus clausii, 0.0068% lipase protein derived from Thermomyces lanuginosus, 0.0068% amylase protein derived from Bacillus licheniformis, 0.0009% cellulase protein derived from Humicola insolens, 21% of surfactant of which 8.1% was LAS, 6.5% was AS, 4.0% was nonionic surfactants, and 2.5% was cationic surfactants (DSDMAC). It further contained 64% builder consisting of fatty acid, carbonate, zeolite A, silicates, and citrate, and also contained 2.7% of dispersing polymers. The enzyme cocktail in this composition was replaced with a new enzyme cocktail consisting of 0.04% protease protein derived from Bacillus clausii, 0.02% amylase protein derived from Bacillus subtilis, 0.03% lipase protein derived from Thermomyces lanuginosus, and 0.0077% of an endo-cellulase derived from Bacillus subtilis.

A full-scale wash was conducted under standard European washing conditions with the following stains: grass stain on cotton (EMPA 164), mineral oil/black ink on cotton (EMPA 106), milk cacao on cotton (EMPA 112), pigment/sebum on cotton (Wfk 10D), vegetable oil/milk/ink on cotton (Wfk 10ppm), used motor oil on cotton/polyester (Wfk 20gm), red wine on cotton/polyester (Wfk 20L), tomato ketchup on cotton/polyester (Wfk 20T), lipstick on cotton/polyester (Wfk 20LS), rice starch on cotton (CS-28), chocolate pudding on cotton (EMPA 170), butter fat on cotton (CS-10), clay on cotton (Wfk 10TE), soiled ballast fabric (Wfk SBL), unsoiled 100% cotton and 100% polyester fabrics, homemade stains of olive oil, beef dripping, chicken fat, lard, and corn oil on blue cotton/lycra fabrics, lard/sudan red stains on white cotton/lycra fabrics, consumer soiled socks and t-shirts (both from Equest Research). The total detergent concentration was 5 g/litre.

The tests showed that by reducing the level of surfactant in the detergent composition to 50% of normal level, and replacing it with the new enzyme cocktail listed above, it was possible to get an equal or better wash result than with the detergent composition with normal level of surfactant.

Wash Result (higher is better)

| | | | | | | Unsoiled |
|---|---|---|---|---|---|---|
| | | | Chicken | Beef | Unsoiled | White |
| Composition | Corn Oil | Lard | Fat | Dripping | Polyester | Cotton |
| Normal level of surfactants | 3.6 | 2.6 | 3.1 | 3.1 | 63 | 58 |
| and original enzyme | | | | | | |
| cocktail | | | | | | |
| Reduced level of surfactants | 2.6 | 2.1 | 2.5 | 2.5 | 60 | 55 |
| (10.5%) and original | | | | | | |
| enzyme cocktail | | | | | | |
| Reduced level of surfactants | 3.5 | 3.0 | 3.2 | 3.1 | 68 | 62 |
| (10.5%) and new | | | | | | |
| enzyme cocktail | | | | | | |

The remission values of the textiles were measured at 460 nm with a UV filter using a MacBeth color eye system.

### Example 14

A standard North American laundry liquid detergent was prepared. It contained 0.02% protease protein derived from Bacillus clausii, 0.0006% cellulase protein derived from Humicola insolens, 0.0033% amylase protein derived from Bacillus halmapalus, and 0.0045% mannanase protein derived from an alkalophilic bacillus, 23% of surfactant of which 16% was AES, 5% was LAS and 2% was nonionic surfactants. It further contained 6% builder consisting of soap, citric acid, DTPA and calcium formate, and 5% polycarboxylate dispersing polymers. The enzyme cocktail used in this detergent was replaced with a new enzyme cocktail consisting of 0.067% protease protein derived from Bacillus clausii, 0.067% of amylase protein derived from Bacillus subtilis, 0.067% mannanase protein derived from an alkalophilic bacillus, 0.067% of pectate lyase protein derived from Bacillus licheniformis, 0.067% endo-cellulase protein derived from Bacillus subtilis, 0.1% lipase protein derived from Thermomyces lanuginosus, and 0.008% cellulase protein derived from Thielavia terrestris.

A full-scale wash was conducted under Standard North American conditions on 15 different stains on 100% cotton from Equest Research (EMPA 102) including baby food, tea, spaghetti sauce, makeup, clay, beta carotene, blood, curry sauce, butter, grass, chocolate dessert, red wine, used engine oil, animal fat/dye, and garden peat. An unstained blank 100% cotton fabric was also included. The detergency of the detergent was calculated by adding the average remissions obtained on each of these stains together for each of the treatments.

Also included in the wash, but not included in the calculations below, were other stains as follows: mineral oil/ink on cotton (EMPA 106), milk cacao on cotton (EMPA 112), grass on cotton (EMPA 164), pigment/sebum on cotton (Wfk 10D), vegetable oil/milk/ink on cotton (Wfk 10ppm), egg yolk on cotton (Wfk 10eg), used motoroil on cotton/polyester (Wfk 20gm), redwine on cotton (Wfk 20L), tomato ketchup on cotton/polyester (Wfk 20T), direct blue dye on cotton (Wfk DB71), colored olive oil on cotton (CS-4), butterfat on cotton (CS-10), lipstick on cotton/polyester (Wfk 20LS), makeup on cotton/polyester (Wfk 20MU), 15 different soils on cotton (EMPA 102), rice starch on cotton (CS-28), chocolate pudding on cotton (EMPA 170), shoe polish on cotton/polyester (Wfk 20S), coca cola on cotton/polyester (Wfk 20H), motor oil on cotton/polyester (Wfk 20M), soot on cotton/polyester (Wfk 20RM), clay on cotton/polyester (Wfk 20TE), soya on cotton/polyester (Wfk 20V), homemade lard/sudan red and sesame oil on white cotton/lycra, olive oil, beef dripping, chicken fat, lard, and corn oil stains on green cotton/lycra. The total detergent concentration was 1.5 g/l.

| | Wash Result |
|---|---|
| | (higher |
| Composition | is better) |
| Normal level of surfactants and no enzyme | 853 |
| Normal level of surfactants and original enzyme | 863 |
| cocktail | |
| Reduced level of surfactants (11.5%) and no enzyme | 636 |
| Reduced level of surfactants (11.5%) and original enzyme | 679 |
| cocktail | |
| Reduced level of surfactants (11.5%) and new enzyme | 851 |
| cocktail | |
| Reduced level of surfactants (17.25%) and no enzyme | 786 |
| Reduced level of surfactants (17.25%) and original enzyme | 866 |
| cocktail | |
| Reduced level of surfactants (17.25%) and new enzyme | 894 |
| cocktail | |

The remission values of the textiles were measured at 460 nm with a UV filter using a MacBeth color eye system.

The original enzyme cocktail gave 1% more overall benefit than nil enzyme detergent at 100% surfactant level. At 50% surfactant level, the original enzyme cocktail gave 7% more overall benefit than nil enzyme detergent and the new enzyme cocktail gave 34% more overall benefit. At 75% surfactant level, the original enzyme cocktail gave 10% more overall benefit than the nil enzyme detergent and the new enzyme cocktail gave 14% more overall benefit.

### Example 15

A standard European laundry powder detergent was prepared. It contained 21% of surfactant of which 8.1% was LAS, 6.5% was AS, 4.0% was nonionic surfactants, and 2.5% was cationic surfactants (DSDMAC). It further contained 64% builder consisting of fatty acid, carbonate, zeolite A, silicates, and citrate, and also contained 2.7% of dispersing polymers.

A launder meter wash was conducted under Standard European conditions with the following stains: grass stain on cotton (EMPA 164), mineral oil/black ink on cotton (EMPA 106), milk cacao on cotton (EMPA 112), pigment/sebum on cotton (Wfk 10D), vegetable oil/milk/ink on cotton (Wfk 10ppm), used motor oil on cotton/polyester (Wfk 20gm), red wine on cotton/polyester (Wfk 20L), tomato ketchup on cotton/polyester (Wfk 20T), lipstick on cotton/polyester (Wfk 20LS), rice starch on cotton (CS-28), chocolate pudding on cotton (EMPA 170), butter fat on cotton (CS-10), and clay on cotton (Wfk 10TE). The total detergent concentration was 5 g/litre.

The tests showed that by reducing the total detergent concentration by either 50 or 75%, and replacing it with 0.01% protease protein derived from Bacillus clausii, 0.01% lipase protein derived from Thermomyces lanuginosus, 0.01% amylase protein derived from Bacillus subtilis, 0.01% endo-cellulase protein derived from Humicola insolens, 50 ECU/L of cellulase protein derived from Thielavia terrestris enzyme, it was possible to get the same or better wash result than with the detergent composition at the full dosage of 5 g/litre.

Wash Result (higher is better)

| Composition | EMPA106 | EMPA184 | Wfk10ppm | Wfk20LS |
|---|---|---|---|---|
| Normal detergent | 39 | 37 | 65 | 65 |
| dosage (5 g/litre) | | | | |
| and no enzyme | | | | |
| Reduced detergent | 36 | | | 63 |
| dosage (2.5 g/litre) | | | | |
| and no enzyme | | | | |
| Reduced detergent | 39 | | | 65 |
| dosage (2.5 g/litre) | | | | |
| and enzyme | | | | |
| Reduced detergent | | 34 | 62 | |
| dosage (1.25 g/litre) | | | | |
| and no enzyme | | | | |
| Reduced detergent | | 44 | 67 | |
| dosage (1.25 g/litre) | | | | |
| and enzyme | | | | |

The remission values of the textiles were measured at 460 nm with a UV filter using a MacBeth color eye system.

### Example 16

A detergent was prepared comprising 0,4% protease (Savinase®), 16,9% surfactants including soap of which 11% was LAS and 5,9% non-ionic and 4,1% soap, and 63% builders.

5 cycles of full scale wash under standard European washing conditions were performed on stained textile using 5 g/l detergent and water hardness of 25°dH. The stained textile was EMPA106 (carbon black/mineral oil on cotton), wfk10D (pigment/sebum on cotton), wfk20gm (used motor oil on polyester/cotton), wfk10TE (clay on cotton), wfk 20RM (soot Mineral oil on polyester/cotton), wfk 20s (shoe polish on polyester/cotton), wfk 20v (Soy sauce on polyester/cotton), wfk20T (Tomato ketchup on polyester/cotton) and wfk 20LS (lipstick on polyester/cotton); EMPA112 (cotton soiled with cocoa), EMPA164 (grass on cotton), wfk 10eg (egg yolk on cotton), EMPA116 (cotton soiled with blood/milk/ink), EMPA117 (polyester/cotton soiled with blood/milk/ink) and wfk10ppm (veg. oil/milk/ink on cotton). The former 8 swatches are considered predominantly sensitive to non-enzymatic detergent components, and the latter 7 swatches are considered predominantly sensitive to enzymes.

As whiteness tracer fabrics were used 100% knitted cotton (wfk80A) and 100% knitted polyester. 20 g of olive oil and 2 sheets of soil ballast fabric (wkf SBL) were added to increase the soil level.

Extra ballast consisting of sheets, t-shirts, shirts, pillowcases and tea towels were added up to 3,8 kg.

The washing experiment was repeated under the same conditions except from decreasing the detergent dosage to 50% of normal level (ie 2,5 gram detergent per liter washing liquor/liter) and addition/no addition an enzyme cocktail consisting of 1,0 mg amylase (Stainzyme™) per liter washing liquor, 2,0 mg lipase (Lipex™ per liter washing liquor, 200 ECU bacterial cellulase per liter washing liquor, (corresponding to 0.75 mg/liter) and 1,5 mg protease (Savinase®) per liter washing liquor was added.

The results showed that by decreasing the total level of detergent to 60% of normal level and replace it with enzyme it was possible to get a better wash result than with the detergent composition with normal level of detergent dosage.

Wash result (higher is better)

| | Detergent | |
|---|---|---|
| | sensitive stains | Enzyme sensitive stains |
| Detergent - 100% of | 466 | 276 |
| normal level | | |
| Detergent - 50% of normal | 443 | 259 |
| level | | |
| Detergent - 50% of normal | 483 | 349 |
| level plus enzymes | | |

The remission values of the textiles were measured at 460 nm with a UV filter using a MacBeth color eye system and summed up.

Wash result (higher is better)

| | 100% cotton | | 100% | |
|---|---|---|---|---|
| | whiteness | | polyester whiteness | |
| | tracer fabric | | tracer fabric | |
| | After 1^{st} | After 5^{th} | After 1^{st} | After 5^{th} |
| | cycle | cycle | cycle | cycle |
| Detergent - 100% of | 85 | 85 | 74 | 67 |
| normal level | | | | |
| Detergent - 50% of normal | 84 | 85 | 75 | 68 |
| level | | | | |
| Detergent - 50% of normal | 84 | 87 | 78 | 75 |
| level plus enzymes | | | | |

The remission values of the textiles were measured at 460 nm with a UV filter using a MacBeth color eye system.

Also the level of inorganic residues in the whiteness tracer fabric was measured, as ash content after incineration at 700° C. The results show that the level of ash is reduced when enzymes are included into a detergent dosed at 50% of normal level, compared to the situation where the normal level of detergent is used, as well as to the situation where 50% of the detergent dosage is used. A reduced ash content is beneficial for the fabric in terms of reduced wear of fabric and achieving a softer feel.

Results of washing and incineration (lower is better)

| | | 100% |
|---|---|---|
| | 100% cotton whiteness | polyester whiteness |
| | tracer fabric | tracer fabric |
| Detergent - 100% of normal | 1.3% | 2.0% |
| level | | |
| Detergent - 50% of normal | 0.6% | 2.3% |
| level | | |
| Detergent - 50% of normal | 0.5% | 1.1% |
| level plus enzymes | | |

Ash content in percentage of fabric weight.

### Example 17

A standard North American laundry powder detergent was prepared. It comprised 16.3% of surfactant of which 7.8% was LAS, 6.7% was AS and 1.8% was nonionic surfactants, and 60% builder comprising fatty acid, zeolite A, carbonate and silicate.

A terg-o-tometer wash under standard North American washing conditions was performed on the following stains: mineral oil/ink (EMPA106), milk cacao (EMPA112), grass (EMPA164), pigment/sebum (WFK10D), veg. oil/milk (WFK10 PPM), lipstick (Wfk20LS), rice starch (CS28), egg yolk (Wfk10EG), Chocolate pudding (EMPA160), makeup (Wfk20MU), motor oil/pigment (Wfk20M), red wine aged (Wfk20LI), and Interlock cotton. The total detergent concentration was 1 g/litre in 800 mL wash solution. 2 swatches of 5×5 cm of each type were used.

The tests showed that by reducing the level of surfactant in the detergent composition to 25% of normal level, and replacing it with 0.05% protease protein derived from Bacillus clausii, 0.1% lipase protein derived from Thermomyces lanuginosus, 0.05% amylase protein derived from Bacillus subtilis, 0.0125% endo-cellulase protein derived from Humicola insolens, and 0.0125% cellulase protein derived from Thielavia terrestris, it was possible to get a similar or better wash result than the detergent composition with normal level of surfactants.

Wash Result (higher is better)

| Composition | EMPA164 | Wfk10EG | EMPA112 | Wfk10ppm |
|---|---|---|---|---|
| Normal surfactant | 30 | 57 | 36 | 47 |
| level and no enzyme | | | | |
| With reduced level of | 29 | 54 | 30 | 43 |
| surfactant (4.1%) | | | | |
| and no enzyme | | | | |
| With reduced level of | 34 | 58 | 43 | 55 |
| surfactant (4.1%) | | | | |
| and enzyme | | | | |

Remission values of the textiles measured at 460 nm with a UV filter using a MacBeth color eye system.

### Example 18

A standard North American laundry powder detergent was prepared. It comprised 14.9% of surfactant of which 11.5% was LAS and 3.4% was nonionic surfactants, and 55% builder comprising fatty acid, zeolite A, carbonate and silicate.

A terg-o-tometer wash under standard North American washing conditions was performed on the following stains: mineral oil/ink (EMPA106), milk cacao (EMPA112), grass (EMPA164), pigment/sebum (WFK10D), veg. oil/milk (WFK10PPM), lipstick (Wfk20LS), tomato ketchup (WFK20T), rice starch (CS28), used motor oil (WFK20GM), clay (Wfk10TE), soy sauce (Wfk20V), HM redwine, HM Tea, Cotton interlock. The total detergent concentration was 1 g/litre in 800 mL wash solution. 2 swatches of 5×5 cm of each type were used.

The tests showed that by reducing the level of surfactant in the detergent composition to 50% of normal level, and replacing it with 0.05% protease protein derived from Bacillus clausii, 0.1% lipase protein derived from Thermomyces lanuginosus, 0.05% amylase protein derived from Bacillus subtilis, 0.0125% endo-cellulase protein derived from Humicola insolens, and 0.0125% cellulase protein derived from Thielavia terrestris, it was possible to get a similar or better wash result than the detergent composition with normal level of surfactants.

Wash Result (higher is better)

| Composition | EMPA112 | EMPA164 | Wfk10ppm | Wfk20LS |
|---|---|---|---|---|
| Normal surfactant | 33 | 30 | 46 | 47 |
| level and no enzyme | | | | |
| With reduced level | 31 | 29 | 41 | 36 |
| of surfactant (7.5%) | | | | |
| and no enzyme | | | | |
| With reduced level | 43 | 37 | 53 | 47 |
| of surfactant (7.5%) | | | | |
| and enzyme | | | | |

Remission values of the textiles measured at 460 nm with a UV filter using a MacBeth color eye system.

### Example 19

A standard North American laundry powder detergent was prepared. It comprised 19.5% of surfactant of which 4.5% was LAS, 13% was AS and 2% was nonionic surfactants, and 61% builder comprising fatty acid, zeolite A, carbonate and silicate.

A terg-o-tometer wash under standard North American washing conditions was performed on the following stains: mineral oil/ink (EMPA106), milk cacao (EMPA112), grass (EMPA164), pigment/sebum (WFK10D), veg. oil/milk (WFK10PPM), lipstick (Wfk20LS), rice starch (CS28), egg yolk (Wfk10EG), Chocolate pudding (EMPA160), makeup (Wfk20MU), motor oil/pigment (Wfk20M), ketchup (Wfk20T), clay (Wfk10TE), paprika (Wfk10P), Interlock cotton, Coca Cola (Wfk10H), shoe polish (Wfk10S), and Coca Cola (Wfk20H). The total detergent concentration was 1 g/litre in 800 mL wash solution. 2 swatches of 5×5 cm of each type were used. The tests showed that by reducing the level of surfactant in the detergent composition to 75% or 50% of normal level, and replacing it with 0.05% protease protein derived from Bacillus clausii, 0.1% lipase protein derived from Thermomyces lanuginosus, 0.05% amylase protein derived from Bacillus subtilis, 0.0125% endo-cellulase protein derived from Humicola insolens, and 0.0125% cellulase protein derived from Thielavia terrestris, it was possible to get a similar or better wash result than the detergent composition with normal level of surfactants.

Wash Result (higher is better)

| Composition | EMPA160 | Wfk20LS | Wfk10EG | EMPA164 | EMPA112 | Wfk10 ppm |
|---|---|---|---|---|---|---|
| Normal surfactant level and no | 51 | 35 | 55 | 29 | 31 | 45 |
| enzyme | | | | | | |
| With reduced level of surfactant | 49 | 31 | | | | |
| (14.6%) and no enzyme | | | | | | |
| With reduced level of surfactant | 62 | 37 | | | | |
| (14.6%) and enzyme | | | | | | |
| With reduced level of surfactant | | | 54 | 28 | 28 | 43 |
| (9.8%) and no enzyme | | | | | | |
| With reduced level of surfactant | | | 59 | 31 | 40 | 50 |
| (9.8%) and no enzyme | | | | | | |

Remission values of the textiles measured at 460 nm with a UV filter using a MacBeth color eye system.

### Example 20

A standard Japanese laundry powder detergent was prepared. It comprised 24.3% of surfactant of which 11.1% was LAS, 11.6% was ester sulfonate and 1.6% was nonionic surfactants, and 60% builder comprising fatty acid, zeolite A, carbonate and silicate.

A terg-o-tometer wash under standard Asia-pacific washing conditions was performed on the following stains: mineral oil/ink (EMPA106), milk cacao (EMPA112), grass (EMPA164), pigment/sebum (WFK10D), veg. oil/milk (WFK10PPM), lipstick (Wfk20LS), tomato ketchup (WFK20T), rice starch (CS28), used motor oil (WFK20GM), clay (Wfk10TE), soy sauce (Wfk20V), Homemade red wine on cotton, Homemade Tea on cotton, and Cotton interlock. The total detergent concentration was 0,5 g/litre in 800 mL wash solution. 2 swatches of 5×5 cm of each type were used.

The tests showed that by reducing the level of surfactant in the detergent composition to 75% of normal level, and replacing it with 0.1% protease protein derived from Bacillus clausii, 0.2% lipase protein derived from Thermomyces lanuginosus, 0.1% amylase protein derived from Bacillus subtilis, 0.025% endo-cellulase protein derived from Humicola insolens, 0.025% cellulase protein derived from Thielavia terrestris, it was possible to get a similar or better wash result than the detergent composition with normal level of surfactants.

Wash Result (higher is better)

| Composition | Wfk20T | Wfk10ppm | Wfk20LS |
|---|---|---|---|
| Normal surfactant level and no | 64 | 37 | 31 |
| enzyme | | | |
| With reduced level of surfactant | 63 | 36 | 28 |
| (18.2%) and no enzyme | | | |
| With reduced level of surfactant | 67 | 40 | 33 |
| (18.2%) and enzyme | | | |

Remission values of the textiles measured at 460 nm with a UV filter using a MacBeth color eye system.

### Example 21

A standard Japanese laundry powder detergent was prepared. 27.9% of surfactant of which 27.5% was LAS and 0.4% was nonionic surfactants, and 64% builder comprising zeolite A, carbonate, citrate, phosphates and silicate.

A terg-o-tometer wash under standard Asia-pacific washing conditions was performed on the following stains: mineral oil/ink (EMPA106), milk cacao (EMPA112), grass (EMPA164), pigment/sebum (WFK10D), vegetable oil/milk (WFK10PPM), lipstick (Wfk20LS), tomato ketchup (WFK20T), rice starch (CS28), used motor oil (WFK20GM), clay (Wfk10TE), soy sauce (Wfk20V), Homemade red wine on cotton, Homemade Tea on cotton, and Cotton interlock. The total detergent concentration was 0,67 g/litre in 800 mL wash solution. 2 swatches of 5×5 cm of each type were used.

The tests showed that by reducing the level of surfactant in the detergent composition to 50% of normal level, and replacing it with 0.075% protease protein derived from Bacillus clausli, 0.15% lipase protein derived from Thermomyces lanuginosus, 0.075% amylase protein derived from Bacillus subtilis, 0.019% endo-cellulase protein derived from Humicola insolens, 0.019% cellulase protein derived from Thielavia terrestris, it was possible to get a similar or better wash result than the detergent composition with normal level of surfactants.

Wash Result (higher is better)

| Composition | Wfk10ppm | Wfk20LS |
|---|---|---|
| Normal surfactant level and no | 44 | 35 |
| enzyme | | |
| With reduced level of surfactant | 42 | 32 |
| (14.0%) and no enzyme | | |
| With reduced level of surfactant | 46 | 38 |
| (14.0%) and enzyme | | |

Remission values of the textiles measured at 460 nm with a UV filter using a MacBeth color eye system.

### Example 22

Conventional nonionic surfactants was in detergents to reduce the effective affinity of lipolytic enzymes for a surface. The effect was shown with Neodol 25-7, having a low CMC near 10 micro molar, good wetting performance and high micellar suspension capacity for e.g. olive oil. From analysis of SPR binding isotherms of the lipolytic enzyme Lipex® to a substrate-like hydrophobic surface (obtained in a pH 9 buffer on a Biacore 3000 instrument with an HPA chip), the maximum adsorption (equilibrium surface excess) of the lipase in the presence of Neodol 25-7 was investigated as a function of surfactant concentration (0-0.5 mM), and was further compared with analogous solutions containing the traditional anionic detergent LAS, and 1:2% w/w mixtures of Neodol 25-7:LAS. An overall linear relationship between adsorption and surfactant concentration was observed. The lipase adsorption was reduced as a function of surfactant concentration more strongly in the order Neodol 25-7>1:2% w/w Neodol 25-7:LAS>LAS. Together with controls, this set of observations was consistent with increasing association of Lipex® to micelles in solution rich in nonionic surfactants.

### Example 23

Adsorption of lipolytic enzyme to a substrate-like surface depends strongly on the composition of the surfactant system. The table below shows results from SPR (Surface Plasmon Resonanc) experiments where adsorption to a hydrophobic surface was measured for suspensions of 400 nM Lipex®+0.01 mM surfactant (obtained in a pH 9 buffer on a Biacore 3000 instrument with a HPA chip). It was clear that the shorter-chain alcohol ethoxylate, Lutensol ON60, gave a higher adsorption of lipolytic enzyme in the presence of surfactants as compared to the longer-chain Neodol 25-7 (pure surfactant adsorption gave signals near 400, whereas Lipex® alone in buffer adsorbed to a level of 2000, all units were in micro gram per square meter). As pointed out earlier, the level of enzyme adsorption were to be optimized in order to maximize the catalytic function, as well as the overall wash effect of the detergent formulation.

SPR results

| | Std. LAS | | Short LAS | | Dobanol 91S | | SDS | |
|---|---|---|---|---|---|---|---|---|
| Non:An | 1:2 | 2:1 | 1:2 | 2:1 | 1:2 | 2:1 | 1:2 | 2:1 |
| Neodol 25-7 | 735 | 779 | 728 | 788 | 1931 | 731 | 555 | 701 |
| Lutensol ON60 | 982 | 890 | 899 | 875 | 1743 | 1767 | 887 | 1184 |
| Neodol 91-6 | 966 | 898 | 954 | 755 | 1755 | 1780 | 1138 | 1377 |

### Example 24

Analogously to example 23, it was clear from activity measurements that Lipex® wash performance depended on the composition of the surfactant system. In the table below are shown the results from a standard ELISA based lipolylic activity assay, where hydrolysis of pNP-palmitate, included in a triolein film, were studied in the presence of 10 nM Lipex®, and 0.1 mM surfactants in a pH 9 buffer. This screening process returned information about the optimal balance between lipolytic enzyme performance, and properties of the surfactant system in terms of electrostatic interactions (ration of anionic/nonionic surfactants), wetting (defined by the critical ad-micellar concentration, CAC) and suspension (defined by the critical micellar concentration, CMC). Consistent with the SPR results, standard LAS with the inclusion of a nonionic with higher CMC, e.g. Lutensol ON60, provided higher lipase performance than with a conventional nonionic like Neodol 25-7.

ELISA results

| | Std. LAS | | Short LAS | | Dobanol 91S | | SDS | |
|---|---|---|---|---|---|---|---|---|
| Non:An | 1:2 | 2:1 | 1:2 | 2:1 | 1:2 | 2:1 | 1:2 | 2:1 |
| Neodol 25-7 | 4.00 | 1.18 | 4.33 | 0.33 | 0.05 | 0.04 | 2.37 | 0.07 |
| Lutensol ON60 | 6.48 | 7.63 | 5.90 | 9.42 | 1.51 | 1.26 | 8.91 | 7.57 |
| Neodol 91-6 | 4.55 | 2.98 | 4.07 | 3.69 | 0.32 | 0.21 | 2.78 | 2.14 |

### Example 25

A number of wash solutions consisting of 50 mM glycin, 10 mM NaCl, 0.1 mM CaCl₂ and 1,5 mM surfactant was prepared. pH were adjusted to 9 and NaHCO₃ added to 5 mM. The 1,5 mM surfactant were a mixture of nonionic:anionic having ratios of 1:0, 4:1, 1:2 or 0:1. The nonionic surfactant were either Lutensol ON60 or Neodol 25-7, while the anionic surfactant was short-chain LAS with an average hydrocarbon chain length of 11. The calcium concentration simulated the water hardness in a builded wash solution so addition of builders was avoided. 2×800 mL of each of the wash solutions were added to two 1200 mL launder-o-meter beakers along with 2 of each of the following swatches (size 5×5 cm): EMPA160 Chocolate pudding, EMPA106 oil/carbon black, EMPA112 milk/cacao, Equest grass circle, Wfk10D pigment/sebum, Wfk10ppm veg. oil/milk, Wfk20LS lipstick, Wfk20MU makeup, CS-28 rice starch, Wfk20D pigment/sebum, Wfk20M motor oil/pigment, Wfk20LI red wine aged, Wfk10TE clay, Interlock cotton (10×10 cm); and Interlock cotton/polyester (10×10 cm). Further an enzyme cocktail providing a wash concentration of 0.1% w/w protease protein (from Bacillus clausii), 0.1% w/w lipase protein (from Thermomyces lanuginosus), 0.05% w/w amylase protein (from Bacillus subtilis), 0.0125% w/w endo-cellulase protein (from Humicola insolens), and 0.0125% w/w cellulase protein (from Thielavia terrestris) to one of each set of two identical wash solutions. The swatches were washed with the washing solution in a launder-o-meter wash with a 10 minute ramp from 25→40° C. followed by 40° C. for 20 minutes. After the wash the swatches were rinsed in running tap water 3 times for 5 minutes before they were dried overnight in darkness at room temperature followed by measuring remission at 460 nm using a ColorEye reflectometer.

The following remission values were measured:

| | Remission | | |
|---|---|---|---|
| | | Without | Enzyme |
| Surfactants | With enzyme | enzyme | effect |
| | Wfk20LS Lipstick on polycotton | | |
| Lutensol | 37 | 35 | 2 |
| Lutensol/LAS 4:1 | 40 | 33 | 7 |
| Lutensol/LAS 1:2 | 43 | 31 | 12 |
| Neodol25/7 | 47 | 47 | 0 |
| Neodol25/7/LAS 4:1 | 43 | 43 | 0 |
| Neodol25/7/LAS 1:2 | 38 | 36 | 2 |
| LAS | 37 | 30 | 7 |
| | Wfk20D pigment/sebum on | | |
| | polycotton | | |
| Lutensol | 62 | 61 | 1 |
| Lutensol/LAS 4:1 | 62 | 58 | 4 |
| Lutensol/LAS 1:2 | 55 | 53 | 2 |
| Neodol25/7 | 70 | 70 | 0 |
| Neodol25/7/LAS 4:1 | 69 | 68 | 1 |
| Neodol25/7/LAS 1:2 | 67 | 66 | 1 |
| LAS | 50 | 45 | 5 |

On both swatches, it was seen that the traditional Neodol 25-7/LAS system gives no or small enzyme performance. If a nonionic surfactant with a higher CMC (Lutensol ON60) were used, better enzyme performance were seen compared to the Neodol 25-7 based surfactant system. On Wfk20LS and a Lutensol:LAS ratio of 1:2, the enzyme performance exceeds the enzyme performance in a LAS-only system.

### Example 26

Standard European color compact laundry powder detergents were prepared. It comprised 21.1% of a surfactant system, of which 8.1% was LAS. 6.5% was AS. 2.5% was Arquat 2T-70, and 4% was non-ionic surfactants, and 64% builder comprising fatty acid, zeolite A, carbonate, citric acid and silicate. The surfactant system was prepared separately from the builder. The surfactant system was prepared either Neodol 25-7 or Lutensol ON60 as nonionic surfactant Washing solutions of 5 g/l of these detergents in water of 14°dH hardness and 5 mM NaHCO₃ where made.

Further washing solutions were prepared in which the surfactant system in the standard European color compact laundry detergent was replaced by mixtures of nonionic:anionic surfactant of 1:0, 4:1, 1:2, or 0:1. The nonionic surfactant was either Lutensol ON60 or Neodol 25-7, while the anionic surfactant was short-chain LAS. The surfactant mixture were added to a washing solution in a concentration of 1,5 mM. The builder was added in a concentration corresponding to a 5 g/L detergent concentration.

2×800 mL of each of these wash solutions were added to two 1200 mL launder-o-meter beakers along with 2 of each of the following swatches (size 5×5 cm): EMPA160 Chocolate pudding, EMPA106 oil/carbon black, EMPA112 milk/cacao, Equest grass circle (only 1 swatch), Wfk10D pigment/sebum, Wfk10ppm veg. oil/milk, Wfk20LS lipstick, Wfk20MU makeup, CS-28 rice starch, Wfk20D pigment/sebum, Wfk20M motor oil/pigment, Wfk20LI red wine aged, Wfk10TE clay, Interlock cotton (10×10 cm), and Interlock cotton/polyester (10×10 cm).

Further an enzyme cocktail providing a wash concentration of 0.1% w/w protease protein (from Bacillus clausii), 0.1% w/w lipase protein (from Thermomyces lanuginosus), 0.05% w/w amylase protein (from Bacillus subtilis), 0.0125% w/w endo-cellulase protein (from Humicola insolens), and 0.0125% w/w cellulase protein (from Thielavia terrestris) to one of each set of two Identical wash solutions.

The swatches were washed with the washing solution in the launder-o-meter wash with a 10 minute ramp from 25→40° C. followed by 40° C. for 20 minutes. After the wash the swatches were rinsed in running tap water 3 times for 5 minutes before they were dried overnight in darkness at room temperature followed by measuring remission at 460 nm using a ColorEye reflectometer.

The following remission values were measured:

| | Remission | | |
|---|---|---|---|
| | | Without | Enzyme |
| Surfactants | With enzyme | enzyme | effect |
| | Wfk20LS Lipstick on polycotton | | |
| Lutensol | 40 | 40 | 0 |
| Lutensol/LAS 4:1 | 39 | 39 | 0 |
| Lutensol/LAS 1:2 | 39 | 36 | 3 |
| Neodol25/7 | 45 | 46 | −1 |
| Neodol25/7/LAS 4:1 | 42 | 42 | 0 |
| Neodol25/7/LAS 1:2 | 38 | 37 | 1 |
| LAS | 42 | 32 | 10 |
| Standard detergent | 41 | 37 | 4 |
| (with Neodol25/7E) | | | |
| Standard detergentd | 44 | 38 | 6 |
| (with LutensolON60) | | | |
| | Wfk20D pigment/sebum on | | |
| | polycotton | | |
| Lutensol | 71 | 69 | 2 |
| Lutensol/LAS 4:1 | 70 | 69 | 1 |
| Lutensol/LAS 1:2 | 69 | 65 | 4 |
| Neodol25/7 | 72 | 71 | 1 |
| Neodol25/7/LAS 4:1 | 71 | 71 | 0 |
| Neodol25/7/LAS 1:2 | 68 | 67 | 1 |
| LAS | 60 | 55 | 5 |
| Standard detergent | 67 | 68 | −1 |
| (with Neodol25/7E) | | | |
| Standard detergent | 68 | 65 | 3 |
| (with LutensolON60) | | | |

On both swatches, it was seen that the traditional Neodol 25-7/LAS system gave no or small enzyme performance, while the largest enzyme performance was seen in the LAS only surfactant system. If a nonionic surfactant with a higher CMC (Lutensol ON60) is used, better enzyme performance is seen compared to the Neodol 25-7 based surfactant system. When the nonion surfactant of the standard detergent has the highest CMC (Lutensol ON60), the enzyme performance is improved on these two swatches.

### Example 27

Model wash experiments were made with butter soiled swatches. The swatches were washed for 20 minutes with lipolytic enzyme and detergent, and nonionic surfactant was added in the last 5 minutes of the wash. Blanks without nonionic addition and controls without lipolytic enzyme were included. The conditions were:
Soiled swatches: 50 microlitre butter per swatch
Lipolytic enzyme: Lipex® available from Novozymes A/S, DK as described in WO 00/60063,
Lipex® dosage: 1250 and 5000 LU/I
Detergent: Commercial European powder detergent with mainly anionic surfactant
Wash solution: 4 g/l of detergent, 15°dH
Wash conditions: 20 minutes, 30° C.
Nonionic surfactant: Neodol® 25-7 (primary alcohol ethoxylate, C12-C15 alcohol with 7-8 moles of ethylene oxide, (trademark of Shell Chemical)).

After rinsing and line drying, the malodor was evaluated as the average of a panel scoring, using a scale from 0 (no odor) to 4 (strong odor). Results:

| | | Blank |
|---|---|---|
| Lipase dosage | Invention | (without nonionic) |
| No lipase (control) | 1.0 | 1.0 |
| 1250 LU/I | 1.4 | 2.2 |
| 5000 LU/I | 2.1 | 3.1 |

Remission of the butter-soiled swatches was measured at 460 nm, and the wash performance was taken as the increase in remission by washing with lipase compared to the control without lipase. Results:

| | | Blank |
|---|---|---|
| Lipase dosage | Invention | (without nonionic) |
| 1250 LU/I | 1.5 | 4.5 |
| 5000 LU/I | 2.5 | 4.0 |

The wash performance was evaluated in the same way for swatches soiled with lipstick. Results:

| | | Blank |
|---|---|---|
| Lipase dosage | Invention | (without nonionic) |
| 1250 LU/I | 9.0 | 5.5 |
| 5000 LU/I | 10.0 | 6.5 |

The results show that release of nonionic surfactant into the wash solution after a lag phase according to the invention reduces the malodor formation while improving the wash performance on lipstick swatches with nearly unchanged performance on butter.

1-33. (canceled)

34. A detergent composition comprising:
a) 0.00001% to 80% of enzyme protein by weight; and
b) a surfactant system providing optimized enzyme affinity for surface-associated or bound substrates as measured by improved enzyme detergency, said surfactant system having a ratio of critical ad-micellar concentration:critical micellar concentration of less than 0.95 in a washing liquor at Standard European conditions or Standard North American conditions or Standard Asia-Pacific conditions.

35. A detergent composition comprising:
a) 0.00001% to 80% of enzyme protein by weight; and
b) a ratio of critical ad-micellar concentration:critical micellar concentration of less than 0.95 and a critical micellar concentration of above 0.1 Mm in a washing liquor at Standard European conditions or Standard North American conditions or Standard Asia-Pacific conditions.

36. A detergent composition comprising:
a) 0.00001% to 80% of enzyme protein by weight; and
b) a critical micellar concentration above 0.1 Mm in a washing liquor at Standard European conditions or Standard North American conditions or Standard Asia-Pacific conditions, wherein at least 0.05% by weight of said detergent composition is a lipolytic enzyme and wherein said surfactant system comprise less than 50% w/w of nonionic surfactant.

37. The detergent composition of claim 34, wherein the surfactant system comprises a nonionic surfactant that is less than 50% w/w of the total surfactant in the surfactant system.
